(19) United States
(12) Patent Application Publication
(10) Pub. No.: US 2014/0079509 A1
(43) Pub. Date: Mar. 20, 2014

(54) MODULAR SYSTEM FOR MACHINE, SPECIAL MACHINE AND PLANT CONSTRUCTION

(71) Applicant: Raymond Olivier Chalverat, Burg (CH)

(72) Inventor: Raymond Olivier Chalverat, Burg (CH)

(73) Assignee: AMEC SYSTEM GMBH, Bleienbach (CH)

(21) Appl. No.: 14/111,124

(22) PCT Filed: Apr. 11, 2012
(86) PCT No.: PCT/CH12/00083

§ 371 Date: Dec. 3, 2013

(30) Foreign Application Priority Data
Apr. 11, 2011 (EP) 11405242.6

(51) Int. Cl. F16B 5/02; F16B 19/02

(52) U.S. Cl. CPC F16B 5/02; F16B 19/02
USPC 411/366.1; 403/408.1; 411/378

(57) ABSTRACT

A modular system for manufacturing structures for machine, special machine and plant construction comprises a plurality of components which are of elongate form and which each have at least two orifices, wherein two components can be connected to one another in a play-free manner by means of a connecting element (1000). This permits the construction of particularly solid and precise structures by which machine elements in machine construction, special machine construction and plant construction can be joined together.

### TECHNICAL FIELD

The invention relates to a modular system for machine, special machine and plant construction.

### PRIOR ART

In machine, special machine and plant construction, technical plants are realized in which, for example by means of a substructure, machine elements are arranged such that they can interact. Here, the interaction may involve a workpiece handover, workpiece machining, energy transport (electrical current, heating medium etc.), or substance transport in general (in any state of aggregation). In the case of a workpiece handover, to be able to transfer a workpiece from one machining station to the next, the machining stations or a handover device are arranged in a suitable manner relative to one another. In the case of workpiece machining, the workpiece is held or guided relative to the machining tool in a holding device. A suitable arrangement of two elements is also necessary in the case of energy of substance transport between the two machine elements. In all cases, this may be achieved by means of a suitable substructure. The technical plants may belong to the fields of process engineering, power engineering, supply engineering, production engineering, machine construction and electric technology, etc.

The building of such a substructure for the arrangement of plant parts as per the prior art has the disadvantage that the construction of a substructure involves a high outlay both in terms of time and also in terms of costs. The constructor of the substructure is typically confronted time and again with completely new problems, and requires a very great deal of experience to erect such constructions. Owing to the variability of the different situations, the constructor must typically firstly analyse the situation in order to subsequently order the components for building the construction, which takes up a great deal of time. Furthermore, the analysis of the situation and the manufacture of the components are highly susceptible to errors, wherein not only the form of the components but rather also the material selection, in particular the load-bearing capacity of the material, may not be selected to be optimal, or may even be selected to be inadequate. Such circumstances may then rapidly result in exorbitant additional expenditure.

### PRESENTATION OF THE INVENTION

It is an object of the invention to provide a system, which falls within the technical field mentioned in the introduction, for machine, special machine and plant construction, which system can be built precisely and quickly.

Said object is achieved by means of the features of claim 1. According to the invention, the modular system comprises a plurality of components which are of elongate form and which each have at least two orifices, wherein two components can be connected to one another in a play-free manner by means of a connecting element.

The elongate components permit the construction of particularly solid and precise structures by which machine elements in machine construction, special machine construction and plant construction can be joined together. Said structures often place high demands on precision, in particular if a structure of said type serves to connect a plurality of machine parts which mechanically interact and thereby exert forces on the structure. According to the invention, said requirements are met through the suitable selection and the high precision of the components. The modular system has the advantage that it can be individually adapted to the respective demands in machine, special machine and plant construction. It is thus possible, for example, for the stability of a structure to be controlled by means of a number of struts, wherein consideration can also be given to economy in that, correspondingly, it is not necessary for an excessive number of struts to be installed. The constructor/assembler can, during use, be provided with a construction kit with different component types with which he can erect a structure for the arrangement of machine parts, lines etc. In this way, further time can be saved because, using the construction kit, no components or only few components need undergo re-machining. If the connecting elements are reversible, that is to say for example are formed as screw connections, the structure can if appropriate be dismantled and used to construct a completely different structure.

The components and the connecting elements are preferably composed in each case of a metallic material, which may be present in different compositions and strengths. In a particularly preferred embodiment, the components and the connecting elements are composed of a steel, in particular a rustproof, acid-resistant steel, for example a steel with high chromium content or tempered steel. A structure which has high stability can be created in this way. Furthermore, it is also possible to use aluminium, copper, nickel etc. and alloys thereof. Here, the material selection is carried out in accordance with the intended use. A person skilled in the art is also familiar with further materials which may be used for the components and the connecting elements. Depending on the demanded mechanical loading and/or chemical resistance, it is also possible for plastics, in particular fibre-reinforced plastics such as Kevlar or carbon-fibre-reinforced plastics to be used.

The components, in particular the different components or constituent parts of the components, and the connecting elements may also be produced from different materials. This has the advantage that the individual components and the connecting elements can be optimized with regard to their loading during use and/or with regard to efficient and cheap production. Furthermore, it is also made possible in this way for certain components to be designed such that they can be re-machined such that these can be adapted by the user using common appliances such as drilling machines, milling machines etc.

Below, the expression “axial” is used in each case to denote an axis which runs coaxially with the axis of a threaded part, in particular of an internal or external thread. The expression “radial” is to be understood in each case to mean perpendicular to the axis. An orifice is defined in each case as a cylindrical recess and has an orifice axis, which in turn is defined as a cylinder axis.

“Play” is to be understood here to mean the freedom of movement between the connecting elements and the two components to be connected. By means of the play-free connection, forces can be absorbed without any risk being posed to the stability of the structure. The connection of the components is preferably free from play both in the axial direction and also in the radial direction with respect to the orifices, wherein freedom from play in the axial direction is preferably independent of the freedom from play in the radial direction.

A connecting element is preferable which is radially free from play already before the axial fixing takes place. This has the advantage that precise positioning of the components in the radial direction can be attained already before the axial fixing takes place. Furthermore, it is also possible in this way for radial forces to be absorbed substantially independently of the axial fixing.

The connecting element is preferably designed such that pinning and screw fastening of at least two components arranged such that in each case one orifice of the at least two components are arranged coaxially can be attained through said orifices. A particularly solid connection of components is created in this way. As a result of the pinning, a large contact surface between the connecting element and the orifice inner wall is attained, as a result of which radial forces can be absorbed in an optimum manner. By means of the screw connection, the components can be pressed axially against one another, whereby a position of the components relative to one another with respect to a centre of rotation defined by an axis of rotation of the screw, and also an axial position, can be fixed.

In variants, depending on the intended use, in particular the demanded precision and the exerted loadings, the pinning may be dispensed with. In this case, the radial fixing may take place via a thread of a screw. To enlarge the contact surface, the orifices may also have an internal thread which interacts with the thread of the screw. This would, however, have the disadvantage that an adjustment of the angle between the components would be possible only to a limited extent.

The modular system is preferably provided in a plurality of, in particular two, structural sizes. The orifices of the elongately formed components are preferably formed in a substantially plate-shaped region. The thickness of the plate-shaped regions preferably lies between 2 and 10 mm, preferably between 3 and 6 mm, particularly preferably approximately 3 or 5 mm. Here, the plate thickness is preferably approximately 3 mm for a smaller embodiment and approximately 5 mm in a larger embodiment. An orifice preferably has a diameter of between 4 and 12 mm, preferably 6.5 mm, for the smaller embodiment, and 10.5 mm for the larger embodiment.

The plurality of orifices may be present in a grid layout. In this case, a hole spacing is preferably between 8 mm and 35 mm, preferably 12.5 mm, for the smaller embodiment, and 25 mm for the larger embodiment. The embodiment is selected in accordance with the respective demands of the application. It is however clear to a person skilled in the art that other plate thicknesses may also be provided which may lie outside the above ranges. All of the above dimensions may basically be varied and adapted as desired for specific fields of use.

In a preferred embodiment, the modular system is present in the form of a construction kit which comprises a plurality of components. The components may furthermore be present in different variants. The components are preferably selected from at least two of the following classes:
a) Bar elements having one or more parallel rows of orifices, wherein there is a spacing a between adjacent orifices in one row and if appropriate between the rows.
   The bar elements are preferably of plate-like form. The plates are preferably rounded in the region of the outermost orifices, coaxially with respect to said orifices. In the single-row embodiments, the rounding has a semi-circular form, whereas in the multi-row embodiments, the rounding is in the form of a quarter circle. In this way, a greater freedom of movement of the bar elements during assembly, or greater freedom for the arrangement of said bar elements, is attained. For example, it is possible in this way for two bar elements which are mounted in each case via an end-side orifice on adjacent orifices of a further bar element to be pivoted relative to one another over a large range without obstructing one another sterically. The bar elements may be of substantially any desired design, in particular with regard to the number of orifices. The single-row and double-row embodiments may have for example between 2 and 20 orifices in a row. The number of rows is preferably 1 or 2, wherein it is also conceivable for more than 2 rows to be provided.
   In variants, the spacings need not imperatively be constant. In particular, the rows may have different spacings to one another. It is also conceivable to omit certain orifices, for example in order to allow the user to individually adapt the arrangement of orifices. In this case, it is advantageous if the user has infrastructure for forming orifices with the necessary tolerance.
b) Linear struts having a row of orifices, wherein adjacent orifices have a spacing of \sqrt{2} a to one another.
   The linear struts are of similar construction to the bar elements and may be used for struttings in a structure. In this way, the stability of the structure can be increased and adapted to the exerted loadings. In contrast to the bar elements, the
   spacing is \sqrt{2} a, such that, when said linear struts are mounted at an angle of 45° with respect to the bar elements, the hole spacings can adhere to the hole pattern of the structure. In a structure, composed of bar elements, which defines a rectangular xy plane and which comprises linear struts at an angle of 45° with respect to an x axis or y axis, two orifices in the x direction or in the y direction respectively are therefore situated n*a apart, wherein n is an integer. The linear struts may however also be oriented at angles other than 45°, for which reason, if appropriate, use must be made of a regulating or setting unit (see below). The linear struts are preferably also rounded in the region of the end-side orifices, coaxially with respect to the orifice, for the same reason as the bar elements. Said linear struts preferably furthermore have, between the end-side orifice and the orifice adjacent to the end-side orifice, a narrowing which is formed as a lateral recess in the plate-like basic form. The recesses are preferably in the shape of a circular segment. This serves, for example, to further increase the freedom of movement of the linear struts during assembly, or freedom of arrangement.
   Instead of the factor \sqrt{2}, another factor may also be provided which maintains the hole pattern if the linear struts are installed at an angle other than 45°.
c) Z struts having two orifices which are arranged at the ends and which are aligned parallel to one another, and wherein axes running through the orifices lie in the Z plane.
   The Z struts preferably have precisely two orifices. The Z struts have, as a base element, a plate-like element which corresponds substantially to that of the bar elements but in which no orifices are provided. At the ends, the plate-like element has in each case one portion bent at an angle of 45° and with an orifice. The two bend angles may also differ provided that the sum amounts in each case to 180°, that is to say the orifices are in any case aligned parallel to one another but the inclination of the base element with respect to an orifice axis may also have a value of, for example, 60° or some other value. Axes through the two orifices lie in the same plane as a longitudinal axis of the base element. The Z strut has rotational symmetry about an axis perpendicular to a longitudinal direction of the base element during a rotation through 180°. The Z struts may be used for strutting between two bar elements in which axes through the orifices run parallel.
   In variants, the Z struts in the plate-shaped element may have additional orifices.
d) C struts which have two coaxial orifices.
   The C struts correspond substantially to the Z struts, wherein merely the bend angle is in each case 90° and wherein the orifices are arranged coaxially. The bent regions are oriented radially on the same side with respect to a longitudinal axis of the base element.
e) Angle struts having two orifices which are arranged at the ends and which are oriented at right angles to one another, wherein axes running through the orifices have a point of intersection.
   The angle struts are formed substantially as per the C struts, wherein the bent regions are aligned to the same side with respect to the longitudinal axis of the base element but are not at right angles with respect to the longitudinal axis. The axes running through the two orifices have an angle of intersection of greater than 0°. The angles between the axis through an orifice and the longitudinal axis may differ on one angle strut. The angle struts are thus designed such that for example bar elements at right angles to one another can be strutted, wherein the angle struts may, depending on the embodiment described above, lie at any desired angle with respect to a bar element. The angle struts may however preferably be dimensioned such that they correlate with the hole pattern of the bar elements when the latter are installed at right angles to one another.
f) Corner elements which comprise three side surfaces connected to one another in pairs orthogonally via an edge region, wherein the side surfaces have in each case at least one orifice. The corner elements permit, during construction, a change in direction, by 90°, of the next component to be connected, thus permitting the construction of three-dimensional structures, for example cuboidal constructions.
   At least two of the side surfaces are preferably formed substantially at right angles, wherein a corner which adjoins two sides which are both not connected to a further side surface may be rounded. A third side surface is preferably either of rectangular or triangular design, wherein in the case of the triangular design, the adjoining side surfaces are connected via two side surfaces which enclose a right angle. In a preferred embodiment, the side surfaces comprise one or two rows of 1, 2 or 3 orifices, wherein combinations of different side surfaces may also be provided in one corner element. However, said side surfaces preferably have equal lengths, that is to say also have a corresponding number of orifices, in the region of the connections.
   In a further embodiment, the corner elements may also enclose an angle of 135° between two of the three side surfaces, whereby a variety of the possible constructions can be further increased.
g) Frame elements, formed as rectangular frames with orifices, wherein adjacent orifices have a spacing a from one another, and/or which frame elements are formed substantially as right-angled isosceles triangles, wherein a spacing between adjacent orifices is \sqrt{2} a on the hypotenuse and a on the cathetus.
   The frame elements are constructed substantially as per the bar elements, and differ merely by the rectangular or triangular design. In the case of the triangular design, the hypotenuse may directly adjoin the final orifice of a cathetus, wherein adjacent orifices of the cathetus have a spacing a and adjacent orifices of the hypotenuse have a spacing \sqrt{2}. The triangular embodiment however also encompasses designs which, strictly speaking, are of pentagonal design, wherein the pentagon encloses a right angle between two identical legs and wherein the legs are adjoined at right angles by in each case one side, said sides being connected to one another via the hypotenuse. Said sides comprise in each case three orifices, resulting, in particular in embodiments with relatively long legs, in a substantially triangular shape. In the smallest embodiment, the hypotenuse thus has precisely two orifices, which are simultaneously assigned to the sides.
   Adjacent orifices of the hypotenuse have a spacing of \sqrt{2} a, whereas the other spacings are a. Despite the not entirely consistent vocabulary, for better legibility, in this embodiment the term “triangle” is used, and that region which does not lie at a right angle is referred to as a “hypotenuse”.
   Both triangle frame types preferably have narrowings on the outer side of the hypotenuse between the end-side orifice, which is in each case also assigned to the cathetus or the side, and the orifice adjacent to the end-side orifice, said narrowings being formed as lateral recesses in the plate-like basic form. The recesses preferably have the shape of a circular segment. The freedom of movement during assembly, or freedom of arrangement, is thereby increased.
   In variants, the triangular embodiment may also be of non-isosceles design. The triangular embodiments are however preferably of right-angled design.
h) Workpiece carrier plates for the mounting of plant elements, said workpiece carrier plates being formed as rectangular plates and having orifices in the corners.
   The orifices of the workpiece carrier plate are preferably aligned parallel to a normal to a surface of the plate. Here, the plant elements preferably comprise machine elements in the form, for example, of constituent parts of a plant belonging to the field of process engineering, power engineering, supply engineering, production engineering, machine construction and electrical engineering. Here, the workpiece carrier plates may have a greater thickness than the bar elements, in particular if it is sought to mount heavy machine elements. On the other hand, the workpiece carrier plate may also be of more lightweight design, in particular if it is used merely as a cover and is therefore not subjected to high loadings. The workpiece carrier plates are preferably formed from steel, wherein plastic, aluminium or further suitable materials known to a person skilled in the art may also be used for example for covering purposes. The workpiece carrier plate is preferably adapted on site, in particular by the user, to the corresponding intended use, wherein for example further orifices or apertures may be formed into the adapter plate.
   In variants, the workpiece carrier plates may also have other forms, such as for example a triangular form or the like. The workpiece carrier plate need not imperatively comprise orifices in the corners; said orifices may also be drilled or milled, or formed using other techniques known to a person skilled in the art, on site by the user.
i) Groove rails, wherein side walls are undercut and orifices are arranged with a spacing a in a groove base, and holding elements which comprise a plate with orifices and a holding part screwed to the plate, wherein when fixed in the groove rail, the holding part engages behind the undercut side walls.

A groove rail comprises, as a base element, substantially a bar element in which no rounded corners are provided. To the sides of the base element and parallel to an orifice axis, the groove rail comprises two parallel side walls which are both arranged on the same side of the base element, resulting substantially in a U-shaped cross section of the groove rail. The side walls are undercut on an inner side so as to yield a groove in the longitudinal direction with respect to the base element, which groove is aligned at right angles to an orifice axis. The groove rail is thus preferably formed as a so-called T-groove rail.

The grooves may be engaged behind by a holding part designed as a screw or as any desired body which corresponds to the dimensions and spacings of the grooves. The holding part may for example be formed as an elongate prism which has a width corresponding to or slightly smaller than the spacing of the grooves. The prism may have an internal thread or an external thread which, when the prism is installed in the groove rail, are typically aligned parallel to an orifice axis. It is thereby possible for a plate, formed in particular as a workpiece carrier plate or else as a bar element or further elements, to be moved in a continuously variable manner along the groove and fixed. This furthermore provides a degree of configuration freedom of the system. The plate and/or the holding part may comprise a guide rail which can be guided in the upper region of the groove rail outside the groove of the side wall. In this way, positioning is simplified and furthermore made more precise. In this way, it is possible for example to build a cross table which can be moved or positioned in an xy plane. For this purpose, two first groove rails can be aligned parallel to one another. By means of the holding parts, in particular the sleeve nut for groove rails (see below), a workpiece carrier plate can be mounted on the first groove rails. Second groove rails can subsequently be mounted on the workpiece carrier plate at right angles to the first groove rails, on which second groove rails in turn a workpiece carrier plate is mounted. It is however clear to a person skilled in the art that the groove rails are suitable for a multiplicity of further uses.

If a connecting element is formed as a screw with a screw head, it may be advantageous if the screw head is not circular in cross section but rather has a special shape, for example a parallelogram shape or a circular shape with two parallel portions in the form of circle segments. In this way, it is achieved that the screw head can be inserted through between the side walls into an orifice of the groove rail, and as a result of the non-circular shape, an abutment of the screw head against the side walls can be realized so as to provide rotational locking during the screw fastening process, for example by means of a nut. The screw heads and the groove rail may be dimensioned such that, when the first screw with the special shape of the head cross section is inserted, a second screw, in particular one with a conventional screw head, can be inserted into the groove rail coaxially with respect to the first screw but in an opposite alignment. For this purpose, the screw heads preferably have a thickness slightly smaller than half of a groove width of a groove of the side wall. In this way, the first screw and the second screw can be located in the groove rail effortlessly in the manner described above. In particular, as a screw connection, use may be made of the sleeve nut, described further below, for groove rails.

The orifices are preferably formed as cylindrical apertures, of constant diameter, in the corresponding elements. The inner wall of the orifices is preferably smooth.

In variants, the orifices may also comprise an internal thread, whereby the connecting element can be formed as a screw. This however has the disadvantage that two elements to be connected by means of the screw cannot be pressed against one another in every relative rotation about the screw axis. This could duly be remedied by virtue of only an outermost one of the elements to be connected having an internal thread, but this would complicate the construction of a structure, in particular because the elements would have to be provided in each case with and without threads. In the case of elements which must imperatively be situated on ends, such as for example the corner elements, said disadvantages would however be eliminated.

The orifices of the elements are preferably toleranced in accordance with DIN H8. By means of high precision of the orifices, it is possible for the connections to be of correspondingly precise design. For this purpose, the connecting elements are preferably also DIN H8 toleranced.

Depending on the field of use and structural size, it is also possible for greater or smaller tolerances to be provided.

It is also clear to a person skilled in the art that the modular system may also comprise further components in addition to the components described above under a) to i). Below, therefore, a description will be given of further components which can additionally be used in the modular system.

The modular system preferably comprises a component which is formed as a regulating element which has two orifices on the ends, wherein a spacing between the two orifices can be varied in a continuously variable manner in a predefined range. The regulating elements have the advantage that, in the case of relatively large structures, inaccuracies which may arise for example as a result of temperature fluctuations can be compensated in a simple manner (in this regard, see below with regard to the expansion element). Furthermore, it is also possible in this way to carry out fine adjustments (in this regard, see also below with regard to the regulating unit and the setting unit).

In variants, the regulating element may also be omitted, in particular if the structures to be formed are relatively small in relation to the component size and are therefore not subjected to a relevant degree to changes in length caused by temperature fluctuations.

The regulating element preferably comprises two elements which are arranged so as to be linearly movable relative to one another and can be fixed relative to one another by means of a clamping screw. Particularly simple fixing of the two elements is attained in this way. Linear mobility is also to be understood to mean the screwing-in of an adjusting screw. In this case, a contact surface of one element (screw) with respect to the second element is moved linearly. The two elements are preferably guided such that only a linear relative movement is possible. This may be achieved for example by means of a rail guide or by means of a screw thread.

In a first embodiment as a linear regulating unit, the regulating unit comprises a crank element which can be connected for example to a bar element. The crank element has a first region which comprises at least one orifice and which is substantially in the form of a bar element. A second region is in turn formed substantially as a bar element but has an elongate, coaxially oriented orifice. The second region of the crank element is axially offset with respect to the orifice of the first region, and is connected in an overlapping manner to the first region with an offset in the longitudinal direction by approximately one half orifice spacing of the bar elements. The elongate orifice is likewise aligned in the longitudinal direction and has a length which lies in the range of a length of a bar element with three orifices. The crank element may, in use, be connected to a bar element or to further components by means of two connecting elements through the elongate orifice. Before fixing takes place, the crank element can now be moved in a continuously variable manner with respect to the bar element in the longitudinal direction. The second region may have an encircling groove which is oriented axially with respect to the elongate orifice, in which groove a washer having two orifices with a spacing a in the longitudinal direction may be arranged. In this way precise, play-free adjustment is made possible in the non-fully fixed state. In a second embodiment as an angular regulating unit, the first region of the crank element is formed substantially as a linear strut. The angular regulating unit is preferably constructed with linear struts and the like.

By means of the first embodiment and the second embodiment, a particularly simple regulating unit is created which can be used advantageously in particular when the components to be connected already have a fixed arrangement, that is to say when the orifice spacing is predetermined. In this case, it is possible in a simple manner for the crank element to be connected via the orifice of the first region to one component and for the bar element or the linear strut to be connected to the other component. The crank element and the bar element or the linear strut can subsequently be connected.

In variants, the two elements may also be arranged so as to be pivotable relative to one another.

The spacing between the orifices can preferably be adjusted by means of an adjusting screw.

A third embodiment of the regulating elements, formed as a linear setting unit, corresponds substantially to the linear regulating unit, wherein the crank element comprises, at an end, an internal thread which is oriented parallel to the longitudinal direction and which interacts with a screw likewise oriented in the longitudinal direction, which screw is mounted in a rotatable and axially fixed manner on a bar element. It is thus possible for the crank element to be set linearly with respect to the bar element by means of a rotation of the screw. To fix a position, it is preferable for a screw to be provided which is oriented axially with respect to the orifices, by means of which screw the crank element and the bar element can be screwed together.

A fourth embodiment, formed as an angular setting unit, differs from the third embodiment merely in that, instead of the corresponding regions being designed as bar elements, a design as per the linear struts is provided.

The third and fourth embodiments may advantageously be used when the orifice spacing of the components to be connected or set is not yet clearly defined, but rather is to be set for the first time. For this purpose, the two elements are connected via their orifices to the components, whereupon the spacing is set by means of the adjusting screw.

In variants, the crank element may also have more than one orifice in the first region.

The modular system preferably comprises an adjusting unit which comprises a fixing element and a screw rotatably mounted on the fixing element, and which additionally has an orifice. Via the orifice, the adjusting unit can be connected by means of a connecting element to a component. The screw is preferably aligned at right angles to the orifice axis. To obtain a particularly compact adjustment unit, the screw is preferably arranged tangentially, spaced apart from the orifice. The screw may for this purpose be formed as a conventional screw with a hexagon head, or else may be formed substantially as a threaded rod with an Allen socket head. A person skilled in the art is also familiar with further screw variants which can be used for this purpose.

The adjusting unit preferably furthermore comprises a fixing device for fixing the screw, wherein the fixing device is designed in particular as a clamping screw, such that the screw can be fixedly clamped when the clamping screw is tightened.

In variants, the fixing device may also be omitted, in particular if, for example, the screw has a flat thread pitch or if the adjusting unit is used exclusively for positioning further components before they are fixed.

It is preferable for the screw to be mounted in a rotatable and axially fixed manner on the fixing element, and for the adjusting unit to comprise an adjusting element which has an internal thread for interacting with the screw and also has a contact region for an orifice. The adjusting element can interact with an orifice of a component such that a relative position between the component and a further component which is connected to the further component via the orifice of the fixing element can be adjusted.

The contact region for an orifice may be in the form of a peg, and may optionally also have an internal thread for a screw by means of which a component can be either loosely guided or also fixed.

In variants, the adjusting element may also be dispensed with, wherein an adjustment is realized merely by means of contacting of the component effected by means of the screw. In this case, the adjusting unit may also be removed again after the adjustment of a relative position of two components and the fixing thereof by means of the connecting elements has taken place.

The modular system preferably furthermore comprises hinge elements. This firstly makes it possible for connections to be created over substantially any desired angle range, and it is secondly also possible, using the workpiece carrier plates, to construct pivotable covers. These are constructed substantially as bar elements which comprise, centrally, a rotary axle orthogonal to the longitudinal axis and to the orifice axis. The rotary axle is preferably formed as a hinge. For this purpose, a first part of the hinge element may have two holed elements, which are arranged spaced apart in parallel and coaxially with respect to the rotary axle, on a longitudinal end of a bar element having 1, 2 or more orifices, wherein a second part on a longitudinal end of a bar element having 1, 2 or more orifices has an element of said type in the centre. The two parts are articulatedly connected through the holes by means of a pin. A person skilled in the art is however also familiar with other embodiments.

The modular system preferably furthermore comprises twist elements. Similarly to the corner elements, it is possible by means of these to create a 90° change in direction, wherein the twist element has the advantage that it takes up a smaller amount of space. The twist elements are substantially formed as per the bar elements with preferably two orifices, wherein however more, for example four, orifices are possible, wherein the orifice axes are at right angles to one another. A first orifice lies above a plane in which the second orifice is situated.

The modular system preferably furthermore comprises joint elements. The joint elements may be assembled in modular fashion, as a result of which they can be adapted for any desired uses. The joint elements may have different basic shapes. A joint element comprises, for example, an angle piece which has two regions at right angles to one another, wherein a first region comprises an orifice and a second region comprises an outwardly projecting sleeve with an internal thread. The inner side of the angle piece is to be understood hereinafter to mean the region enclosed at a right angle by the two sides. The sleeve has an outer diameter which substantially corresponds to the inner diameter of an orifice, for example of a bar element. In this way, it is possible, depending on the length of the sleeve, for one or two components to be screwed to the angle piece by means of a suitable screw, wherein the screw is preferably formed as a cap screw as described further below. The joint element furthermore comprises a part formed substantially as a twist element to which, at both sides, via an orifice, an angle piece can be screwed such that the internal thread axes of the two angle pieces lie in a plane, whereby a universal joint is created. The part preferably comprises two orifices, wherein the two orifice axes lie in the same plane. In this way, the cardan joint can be of duplex form by virtue of in each case two angle pieces being screw-fastened via the two orifices. Instead of the second orifice, the part may also have a sleeve which is oriented at right angles to the orifice axis and which has an internal thread or a region suitable for welding to a further component. Finally, the part may also be formed substantially as a spacer sleeve.

The modular system preferably furthermore comprises spider elements. The spider elements are constructed substantially as per the bar elements and may be provided in a wide variety of forms. Taking as a starting point a bar element having three rows and three columns of orifices, which itself is even defined as a spider element, it is now possible for any desired contiguous regions with orifices to be omitted, whereby a first class of spider elements is attained. In this way, for example, a right-angled spider element with 5 orifices or a star-shaped spider element with 5 orifices is attained. Furthermore, the spider elements however also comprise, for example, an element with three orifices arranged in a regular triangle, or a crank element formed substantially as a bar element, said crank element having a cranked portion with the thickness of the bar element between two orifices. The latter may for example be used in order to form, by means of two bar elements and one crank element, a stable triangle which does not have any stresses.

The modular system preferably furthermore comprises angle elements. The angle elements permit a change in direction during the connection of two components, for example of two bar elements, by an angle of 45° or 90°. The angle elements preferably comprise between two and four orifices and may be formed substantially as bar elements or spider elements which have an angle. For this purpose, two orifice axes of an angle element have an angle of 45° or 90°. As a result of the angle, two adjoining parts are defined which each comprise at least one orifice. Said parts may, if more than one orifice is provided, run with the orifice row parallel or at right angles to an axis orthogonal to the angle. One part may also even for example be connected in turn to an additional part which has an orifice, such that the orifice axis of the additional part is arranged at right angles to an orifice axis of the part.

In variants, the angles may also have any other desired values. The angle elements need not imperatively be restricted to having two to four orifices.

The modular system preferably furthermore comprises U elements. This permits an axial offset, with respect to the orifices of the components, of a subsequent component. The U elements are formed substantially as per the bar elements, wherein the two orifices at the ends are bent at right angles towards the same side. The U elements typically comprise a total of three or four orifices, wherein more than four orifices may also be provided. U elements also encompass substantially cuboidal elements in which two adjoining side surfaces are omitted, and in which each side surface comprises at least one orifice.

The modular system preferably furthermore comprises box elements. These may be used in a versatile manner; it is in particular possible by means of these to define an orthogonal system for a structure. The box elements are of cuboidal design, wherein one or two top surfaces are omitted such that a connecting element can be guided from both sides into an orifice. The first side surfaces comprise one to two rows each with one to three orifices. The second side surfaces correspondingly comprise one to two rows with one orifice, whereby the top surface comprises one row with one to three orifices.

The box elements are not necessarily restricted to those described above, but rather may also be of some other design. For example, the top surface may also have more than one row of orifices. It is also conceivable for a box element to be formed which has two top surfaces, in particular if the orifices comprise, for example, an internal thread.

The modular system preferably furthermore comprises support elements. By means of these, a structure can be fastened to the ground. For this purpose, the support elements comprise a plate-like region with holes which may be formed as orifices, which plate-like region is provided for fastening to the ground. Said region may be of any desired form. Furthermore, the support element may comprise a connecting region for the structure, which connecting region is connected at right angles to the region for fastening to the ground and may for example be in the form of a bar element or an angle element with one to three orifices or a T-shaped element with three orifices.

The support elements may also be used as an upper termination for the mounting of a workpiece carrier plate or the like.

The modular system preferably furthermore comprises prism modules. These can serve to hold pipelines or other elements of rod-like form. The prism modules comprise two parallel plate-like elements which are fastened to one another and which are of substantially rectangular design and which have a V-shaped cutout into which the bar-like elements can be placed. The plate-like elements have a plurality of orifices via which they can be connected to further components. Between the two plate-like elements there is fastened a bracket. The bracket comprises a V-shaped element with flanges arranged at the edges, said flanges having threadless bores, and comprises a bar-like element which has, at the edges, in each case one bore with an internal thread. The rod-like element is fastened between the plate-like elements, and the V-shaped element is connected to the plate-like element by means of screws such that a substantially square or rhomboidal intermediate space for receiving the rod-like element is formed by the V-shaped cutouts of the plate-shaped element and the V-shaped element. It is thereby possible for rod-like elements of different diameters and forms to be held depending on the position of the screws.

The modular system preferably furthermore comprises wedge flanges. It is thereby possible to provide V-shaped configurations for the structure. The wedge flanges are of substantially prismatic form with a circle-segment-shaped cross section. Here, the internal angle of the circle segment may be of any desired value. On the side surfaces arranged at right angles to the cross-section surface, the wedge flange comprises a plurality of sleeves which have an internal thread and which are dimensioned such that they can be guided into an orifice of a component, for example of a box element. A screw, in particular a cap screw as defined below, can subsequently be screwed into the internal thread of the sleeve. A wedge flange preferably comprises, at both sides, a laterally arranged row of two sleeves aligned radially or axially with respect to the prism. The screw and sleeve may be designed as per the following description.

The connecting element is preferably formed as a screw connection, having a first element comprising an external thread and a first head part, and having a second element comprising an internal thread and a second head part, characterized in that, when the first element is screwed fully into the second element, a surface between the first head part and the second head part is formed as a smooth circular cylinder which is suitable in particular for pinning.

In this way, a screw connection is created which can absorb both axial forces by means of the screw fastening and also radial forces by means of the pinning, that is to say via the region formed as a smooth circular cylinder. The pinning action however necessitates that the receptacles of the components to be screwed together have a diameter corresponding to the circular cylinder. This is advantageous in particular in structures which require a high degree of precision. In relation to conventional screw fastenings, it is advantageous that the threaded part is not in contact with the elements to be screwed together, with the result that the risk of damage to the threaded part in the region of contact with the elements to be screwed together can be reduced. Furthermore, it is possible in this way for the screw fastening itself to be of more compact design. The threaded part of the first element and that of the second element can therefore be of greater axial length, as a result of which radial and in particular also axial forces can be better absorbed. During use, pinning can be attained already after the insertion of the second element with the internal thread into the receptacles of the components to be connected, in particular before the first element has been screwed in. The building of a structure is thereby simplified because, as a result of the pinning action imparted by the second element already before the screw fastening process, the radial forces can be absorbed and therefore the radial position, in particular the radial precision, is thus already provided. The internal thread of the second element is preferably arranged coaxially with respect to and within the smooth circular cylinder.

In variants, the components may also be riveted to one another via their orifices. A person skilled in the art is also familiar with further connecting techniques which satisfy the requirements in machine, special machine and plant construction.

It is preferable if the first element can be screwed with the second element axially into at least two positions, wherein the spacing between the first head part and the second head part is greater in the first axial position than in the second axial position. In this way, it is for example possible for three components of the same thickness to be screwed together in the first position, and for two such components to be screwed together in the second axial position. It is also possible for more than three components to be screwed together in the first axial position and for more than two components to be screwed together in the second axial position. In particular, the screw fastening may also take place in more than two axial positions; typically the spacing between the head parts can be varied continuously between the maximum and the minimum spacing. In particular in the first axial position, the surface between the first head part and the second head part need not imperatively be formed entirely as a smooth circular cylinder. The external thread, or a part which adjoins the external thread and which is situated between the head part and the threaded part, of the first element may also project in regions out of the smooth circular cylinder and, in said region, have a smaller diameter than the circular cylinder. In said region, the component is not supported radially. This is not a problem in particular if the component which comes to rest in said region is at least partially held radially by the smooth circular cylinder. Said region preferably has, with respect to the component, an axial length of at most approximately one third of the axial length of the receptacle of the component, such that the component is nevertheless adequately held radially, and the pinning is ensured.

The external thread of the first element and the internal thread of the second element are preferably not of conical design, in order to be able to realize both axial positions.

The first element is preferably formed as a cap screw. The head part of the first element is thereby formed as a cap of the cap screw. It is thereby possible for the forces exerted in the corresponding axial direction to be absorbed via the cap of the cap screw. The cap has a contact region for a tightening tool, such that the screw connection can be tightened via the cap of the cap screw (see further below).

In variants, the first element may also be of some other design, wherein preferably the head part has a radially greater cross section than the threaded part.

The external thread part preferably comprises an encircling groove adjacent to the first head part. It is thereby possible, in the second axial position, for a part of the smooth circular cylinder to be received in the groove. Furthermore, it is made possible in this way that, in both axial positions, the components can be held axially between the head parts without additional elements, while the pinning remains ensured. For this purpose, the groove has an outer diameter which substantially corresponds, in particular as a function of the admissible length tolerance of the diameter, to the outer diameter of the smooth circular cylinder. The inner diameter corresponds approximately to the outer diameter of the external thread of the first element. It is thereby ensured that the internal thread can be screwed into the groove.

The groove is U-shaped in cross section, wherein the opening is oriented in the axial direction, in particular in the direction of the thread.

In variants, it is also possible to dispense with the encircling groove. In this case, washers or spacer sleeves could ensure the axial fixing of the components.

The second element is preferably formed as a sleeve nut, wherein the sleeve is formed as a smooth circular cylinder, which is in particular suitable for pinning, and has an internal thread. The internal thread is preferably formed coaxially with respect to the sleeve. The head part preferably has a greater diameter than the sleeve, such that said head part can also serve for fixing the components axially. The head part may be formed as a sleeve nut head, similar to a screw head, or as a radially outwardly projecting edge of the sleeve. The sleeve nut head may have a hexagon socket. Furthermore, the internal thread may also extend through the sleeve nut head, wherein the outer contour of the sleeve nut head has a shape on which a tool can engage in a rotationally conjoint manner during the screw fastening process. Said outer contour may for example be in the form of a polygon, in particular an octagon or hexagon. At an end opposite the sleeve nut head there may be provided an undercut, that is to say a thread-free region. The internal thread may also be formed in a blind hole, wherein the sleeve nut head thereby does not have an orifice which communicates with the internal thread. Such a design may be advantageous in particular in the chemical and/or pharmaceutical industry, because it is not possible for dirt to infiltrate into the region of the internal thread from the sleeve nut head side.

In a preferred embodiment, the diameter of the smooth circular cylinder is 6.5 mm or 10.5 mm and has an H tolerance of preferably 7 or 8. The spacing between the head parts in the second axial position may be for example 6 mm or 10 mm respectively in the first, shorter embodiment of the sleeve nut, and 12 mm or 20 mm respectively in the second, longer embodiment of the sleeve nut. It is self-evident that all of the dimensions specified may be varied as desired.

The cap screw need not imperatively comprise a groove, but rather may also be formed substantially as a conventional screw. If the cap screw does not comprise a groove, the sleeve nuts may be provided in a corresponding plurality of different lengths. The components may basically also be connected to one another in some other way. In this regard, a person skilled in the art is also familiar with further possibilities; in particular, use may also be made of conventional screw connection, pinning or riveting techniques.

The screw fastening system preferably furthermore comprises stepped pins which are composed of two coaxial regions arranged axially in series, wherein a first region has a first outer diameter and a first inner diameter, and a second region has a second outer diameter and a second inner diameter, wherein in particular the two inner diameters and outer diameters respectively may also be identical. The two regions preferably correspondingly comprise different internal threads. The internal threads may be designed such that components of the large structural size can be connected to components of the small structural size. The internal thread may however also comprise other, in particular conventional internal threads.

Further advantageous embodiments and combinations of features of the invention will emerge from the following detailed description and from the entirety of the claims.

### BRIEF DESCRIPTION OF THE DRAWINGS

In the drawings used for explaining the exemplary embodiment, in each case in oblique views:

FIG. 1 shows components from the classes of bar elements and compensation modules;

FIG. 2 shows components from the classes of linear struts, angle struts, Z and C struts;

FIG. 3a-3b shows components from the classes of regulating and setting units;

FIG. 4a-4b shows components from the classes of hinge elements, twist elements, joint elements and spider elements;

FIG. 5a-5b shows components from the classes of angle elements, U elements and box elements;

FIG. 6 shows components from the classes of corner elements and support elements;

FIG. 8 shows components from the class of workpiece carrier plates;

FIG. 9 shows components from the class of groove rails;

FIG. 10 shows components from the classes of readjustment units;

FIG. 11 shows components from the class of holders and adapters;

FIG. 12 shows components from the classes of prism modules and wedge flanges;

FIG. 13 shows an application with prism modules;

FIG. 14 shows a structure produced from a combination of elements of different classes;

FIG. 15 shows a cross table constructed from elements of different classes;

FIG. 16a shows a sectional illustration along a longitudinal axis of a cap screw of the first embodiment;

FIG. 16b shows a schematic plan view of the head part of the cap screw as per FIG. 16a;

FIG. 17a shows a sectional illustration along a longitudinal axis of a short sleeve nut of the first embodiment;

FIG. 17b shows a schematic plan view of the cap of the sleeve nut as per FIG. 17a;

FIG. 18a shows a sectional illustration along a longitudinal axis through a screw connection of the first embodiment with a short sleeve nut in the second axial position, wherein two components are screwed together;

FIG. 18b shows a sectional illustration along a longitudinal axis through a screw connection of the first embodiment with a short sleeve nut in the first axial position, wherein three components are screwed together;

FIG. 19a shows a sectional illustration along a longitudinal axis through a screw connection of the first embodiment with a long sleeve nut in the second axial position, wherein four components are screwed together; and

FIG. 19b shows a sectional illustration along a longitudinal axis through a screw connection of the first embodiment with a long sleeve nut of the second embodiment in the first axial position, wherein five components are screwed together;

FIG. 20a shows a sectional illustration along a longitudinal axis of a cap screw of the second embodiment;

FIG. 20b shows a schematic plan view of the head part of the cap screw as per FIG. 20a;

FIG. 21a shows a sectional illustration along a longitudinal axis of a short sleeve nut of the second embodiment;

FIG. 21b shows a schematic plan view of the cap of the sleeve nut as per FIG. 21a;

FIG. 22a shows a sectional illustration along a longitudinal axis through a screw connection of the second embodiment with a short sleeve nut in the second axial position, wherein two components are screwed together;

FIG. 22b shows a sectional illustration along a longitudinal axis through a screw connection of the second embodiment with a short sleeve nut in the first axial position, wherein three components are screwed together;

FIG. 23a shows a sectional illustration along a longitudinal axis through a screw connection of the second embodiment with a long sleeve nut in the second axial position, wherein four components are screwed together; and

FIG. 23b shows a sectional illustration along a longitudinal axis through a screw connection of the second embodiment with a long sleeve nut in the first axial position, wherein five components are screwed together.

FIG. 24 shows a plan view and a sectional illustration along a longitudinal axis through a long sleeve nut and a short sleeve nut for groove rails;

FIG. 25 shows a spacer disc;

FIG. 26 shows oblique views of three embodiments of stepped pins.

Identical components are basically denoted by the same reference numerals in the figures.

### WAYS OF IMPLEMENTING THE INVENTION

Examples of components of the lightweight embodiment will be described below on the basis of the figures. Unless stated otherwise, the components are formed from steel plates with a thickness of 3 mm. The orifice diameters are in each case 6.5 mm. The expression “bend” should not imperatively be understood to mean a production method. Below, a spacing between two orifices is to be understood to mean an axis spacing between the orifice axes. The first, second and third spatial directions used throughout form an orthogonal system.

The selected terminology for the individual components does not constitute a restriction to the use thereof. It is in each case clear to a person skilled in the art that there are no limitations on the use of the components. For example, linear struts described below need not exclusively be used as struts in a structure.

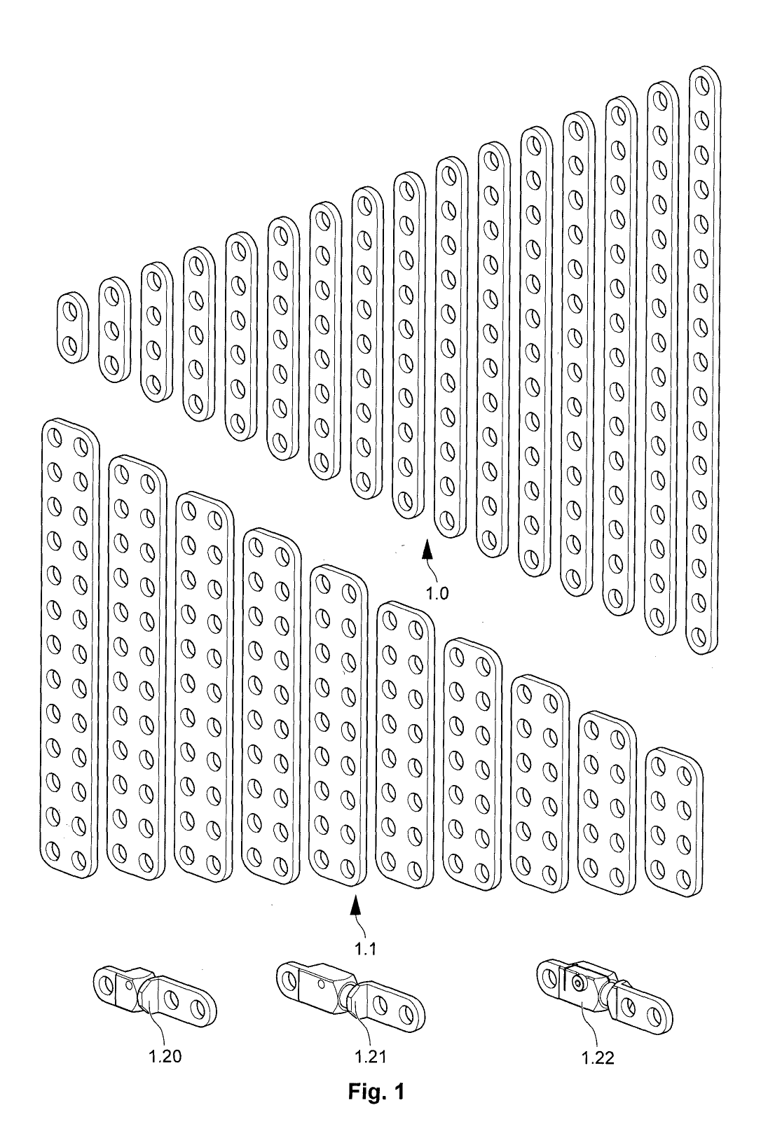

FIG. 1 illustrates exemplary embodiments of elements from the classes 1.0 “single-row bar elements”, 1.1 “double-row bar elements” and 1.2 “compensation modules”.

Here, a first, substantially square bar element 1.0 is composed of an elongate strip of steel with a length of approximately 25 mm in a second spatial direction, having two parallel sides with a width of approximately 12.5 mm in a second and a third spatial direction, to parallel surfaces which are parallel to and at right angles to the sides and which have a width 3 mm and a length 25 mm in a first and a second spatial direction, two end surfaces which are at right angles to the sides and which adjoin the surfaces, and two orifices which are formed in the first spatial direction and in the centre between the two surfaces, said orifices having a standard diameter of 6.5 mm and a standard edge spacing of 6 mm to one another (yielding a hole spacing of 12.5 mm). Opposite ends of the strip are formed so as to be of semi-circular shape, wherein the centre of said semi-circle coincides with the centre of the orifice formed at said end, and the radius difference amounts to approximately 3 mm. The figure also illustrates further bar elements which conform to the embodiment and which are of greater length, said further bar elements comprising between two and seventeen orifices, but the manner of construction of said further bar elements being analogous to that of the bar element 1.0 with two orifices, and the orifices of said further bar elements all lying on a line parallel to and central with respect to the surfaces.

Likewise illustrated in FIG. 1 are bar elements from the class 1.1 “double-row bar elements” which are composed of plates having two parallel sides with a width of approximately 25 mm in the third spatial direction, having two parallel surfaces which are at right angles to the sides and which have a width of 3 mm in the first and the second spatial direction and which define a wall thickness of the element in the first spatial direction, and having two adjacent rows of orifices (each with between four and thirteen orifices in the designs shown) spaced apart in the third spatial direction again by the standard edge spacing of 6 mm. Said two rows of orifices are formed analogously to the rows of orifices of the elements of the class 1.0 “single bar elements” and are arranged parallel to one another such that the centres of adjacent holes of the two rows lie on a connecting line which is perpendicular to the connecting line of the centres of the orifices of one row and which has a mutual edge spacing of 6 mm. The design of said elements is otherwise similar to the elements of class 1.0 “single bar elements”. Elements of this class 1.1 have, at the ends, corners of the sides which are rounded in the form of a quarter circle, wherein the centre of said rounding coincides with the centre of the orifice situated close to said corner, and the radius difference is 3 mm.

Also illustrated in FIG. 1 are elements from the class 1.2 “compensation modules”. These are composed of two parts which can be displaced relative to one another in parallel. Both parts have the basic shape of a single-row bar element 1.0, wherein the first part comprises one orifice and the second part comprises two orifices. The first part furthermore comprises, on the surface, a guide sleeve which has a guide orifice with an axis, wherein the axis perpendicularly intersects the orifice axis. The guide sleeve has a guide groove oriented in the longitudinal direction. The second part has a bolt which corresponds to the guide sleeve and which has a longitudinal axis perpendicular to the orifice axes. The bolt is guided in the guide sleeve and is radially secured at the side by means of a pin which is guided in the guide groove. The guide groove furthermore functions as an axial limitation for the relative movement of the two parts. The illustration shows an embodiment 1.20 “radial compensation module” with a relatively short guide sleeve, an embodiment 1.21 “axial-radial compensation module” with a longer guide sleeve, and an embodiment 1.22 “axial-radial compensation module, fixable” which substantially corresponds to embodiment 1.21 but additionally comprises, in the guide sleeve, a fixing screw which is oriented parallel to the orifices and by means of which the two parts can be fixed relative to one another.

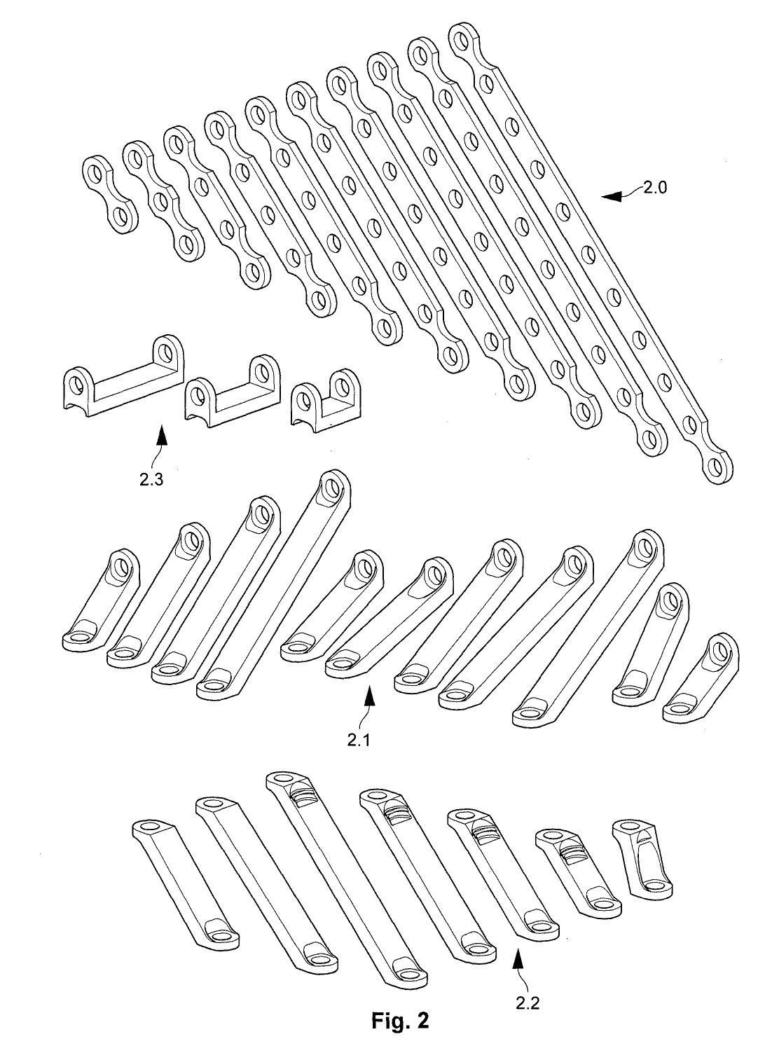

FIG. 2 illustrates exemplary embodiments from the classes 2.0 “linear struts”, 2.1 “angle struts”, 2.2 “Z struts” and 2.3 “C struts”. A linear strut 2.0 which is shown is composed, like the elements of the class 1.0 “single-row bar elements”, of an elongate strip with the same side width and surface width and with five orifices formed analogously to the elements of the class 1.0 “single bar elements”. In each case two adjacent orifices however have a hole spacing increased in relation to that of the bar elements by a factor of \sqrt{2}, thus permitting a diagonal connection between two orifices of bar elements of classes 1.0 or 1.1 standing at right angles to one another and in the same plane, wherein the sides of the linear strut lie in the same plane as the sides of the two bar elements and enclose an angle of 45° with each of the two bar elements. A further difference in relation to the stated elements of class 1.0 consists in two semi-circular recesses in the side width formed symmetrically on the two surfaces, at right angles to the sides, between the in each case final two orifices at an end. Such a recess has a diameter of approximately side width/\sqrt{2} mm, and the two recesses are formed such that the remaining minimal side width approximately corresponds to the orifice diameter. If a linear strut 2.0 has only two orifices, two analogous recesses are formed between said two orifices.

Likewise shown in FIG. 2 are elements from the class 2.1 “angle struts” composed of two end plates which form the respective end and which stand at right angles to one another and of an interposed elongate strip. Said end plates have a side length of approximately 12.5 mm and a wall thickness of 3 mm, the end plates having, on the sides, a centrally formed orifice of standard diameter, and the end of said end plates being rounded analogously to the elements of class 1.0 “single bar elements” (see FIG. 1). Two such end plates stand with their sides perpendicular to one another and are arranged such that the surfaces, which lie between the two non-rounded corners, of the two plates likewise stand at right angles to one another and are adjacent to one another. Said two surfaces are connected by an elongate strip of analogous dimensions to the strips of the elements of class 1.0 “single bar elements”, but without orifices, in corresponding lengths such that the distance both in a first and also in a third spatial direction between the orifices to be connected may amount to between one and four orifices, which leads to the illustrated exemplary embodiments. The sum of the angles between the end plates and the elongate strip amounts in each case to 270°. It is thus possible, for example, for the two angles to be 135°, or for a first angle to be 110° and a second angle to be 160°, etc. Said elongate strip has, at its two ends, semi-circular cutouts whose centre coincides with the central point of the orifice of the respective end plate and which, around the orifice, form a cut-out edge of approximately 3 mm width for receiving a screw head.

Also shown in FIG. 2 are elements from the class 2.2 “Z struts” which are substantially of analogous construction to the elements of class 2.1 “angle struts”, but the end plates of which Z struts lie with their sides (and therefore the axes of the orifices) parallel to one another, and in which Z struts the distance between the orifices to be connected is in each case equal in a first and a third spatial direction. Here, the axis spacing of the orifices of the end plates corresponds to a multiple of an orifice spacing of a bar element.

Also illustrated in FIG. 2 are elements from class 2.3 “C struts”. These, like the elements of class 2.2 “Z struts”, have two parallel end plates of analogous design lying in a first and a second spatial direction, but in these elements the orifices of said end plates are however arranged coaxially with respect to one another. Said two end plates are connected by a strip which is attached at right angles to both end plates and which is elongate in a third spatial direction and which has a U-shaped cross section, wherein an interior of said U-shaped strip is situated on that side of the strip which faces away from the orifices of the end plates.

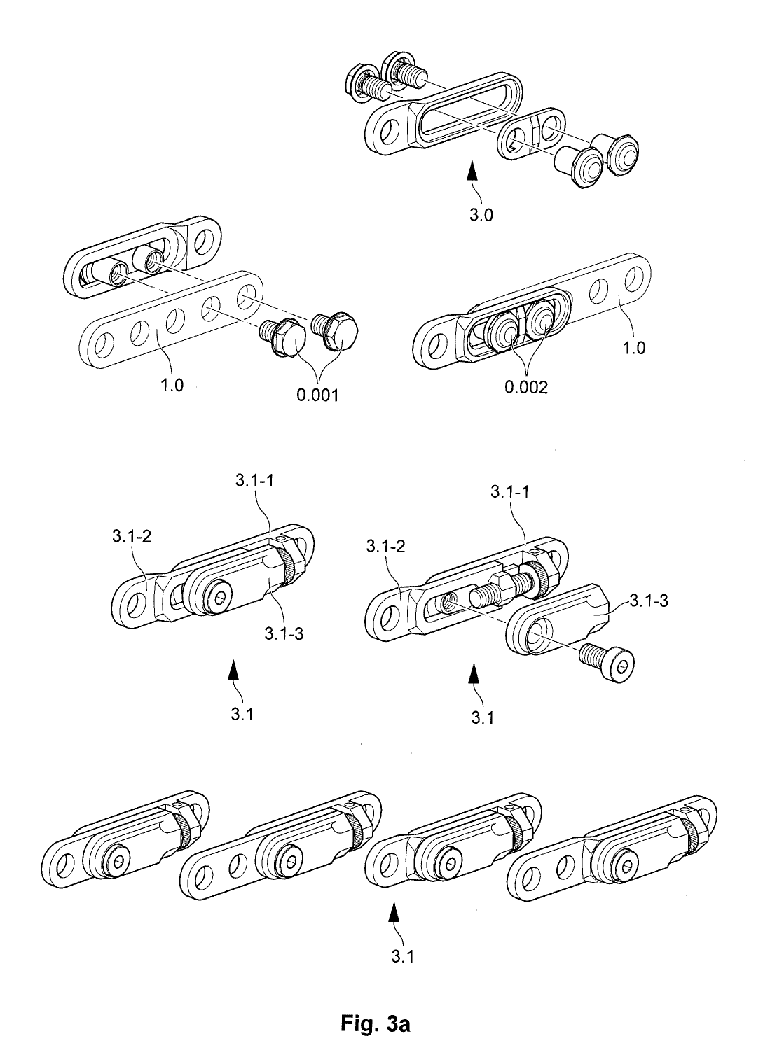

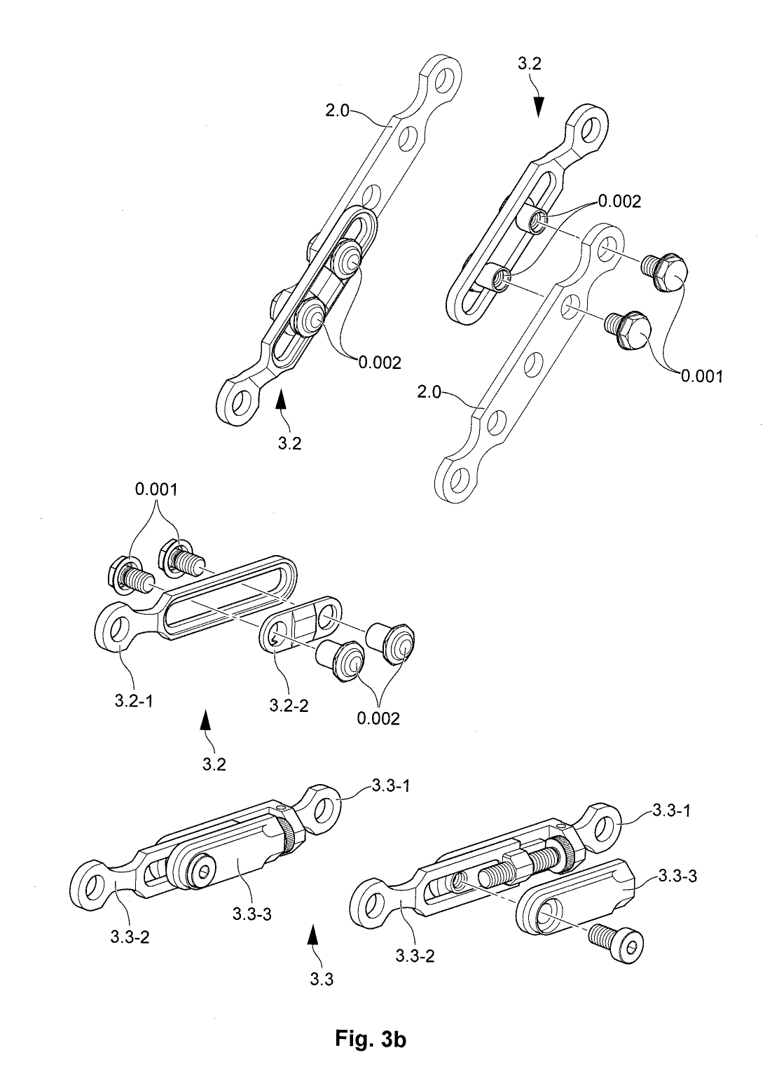

FIGS. 3a, 3b illustrates exemplary embodiments of the lightweight embodiment of elements of classes 3.0 “linear regulating unit”, 3.1 “linear setting unit”, 3.2 “angular regulating unit” and 3.3 “angular setting unit”.

A linear regulating unit of class 3.0 as shown comprises two strips which are elongate in a second spatial direction and which are rigidly fixed with respect to one another and which are dimensioned analogously to the strips of the elements of class 1.0 “single bar elements”, wherein one of said first strips is slightly longer than an orifice diameter and has, at a first end, an orifice which has an axis in a first spatial direction and which again has a standard diameter; the length of a second of said strips corresponds approximately to the length of a bar element having three orifices. Said second of the strips has a single elongate orifice formed by the connection of three orifices identical in form and arrangement to those of the elements of the classes already described. Furthermore, said second of the strips has a reduced wall thickness with a certain width formed around said single elongate orifice on one side of the strip. Here, said width is selected such that an edge remains on the side on which the wall thickness of the orifice is reduced. A recess thus attained by the reduction of the wall thickness serves to receive a carriage which is movable in the elongate orifice and which corresponds in terms of design to an element of class 1.0 “single bar elements” with two orifices but which has a wall thickness corresponding to the reduction in the wall thickness of the second of the strips, and the side width of which carriage in a third spatial direction allows the fixing plate to be located in a countersunk manner in the recess. The carriage has, centrally and between the two orifices, a rib as a rotation prevention means for the sleeve nut. In the present examples, the two fixedly connected strips are offset relative to one another in a fastening plane by the thickness of a bar element 1.0. It is however basically also possible for the two fixedly connected strips to lie in the same plane.

A regulating unit 3.0 of said type can be screwed for example to a bar element 1.0 by means of two cap screws 0.001 and sleeve nuts 0.002. The second of the two strips is fixedly connected with one of its ends to a second end of the first of said two strips, wherein the surfaces of said two strips are arranged in each case parallel to one another, and the sides of the two strips are arranged on one another in an accurately fitting manner in an overlap region. The fixing plate is countersunk in the recess formed on the second of said strips, and receives the two sleeve nuts 0.002 which are inserted from the same side as that from which the recess is formed. The sleeve nuts 0.002, after passing through the fixing plate, pass firstly through the single orifice of the second of the strips of the regulating unit 3.0, subsequently in an accurately fitting manner through two adjacent orifices, situated at one end, of the bar element 1.0, and finally into the sleeve nuts which can be tightened in order to fix all of the parts against one another. Said two orifices of the bar element 1.0 are selected such that the bar element 1.0 comes to rest in the same plane as the first of the two strips of the regulating unit 3.0 and forms the elongation thereof in the second spatial direction. Overall, therefore, a component is constructed which permits the parallel movement and continuously variable fixing of the bar element 1.0, used as an example, relative to the first of the two strips of the regulating unit 3.0.

Likewise illustrated in FIGS. 3a, 3b are elements of class 3.1 “linear setting unit”, which are constructed substantially from three parts 3.1-1, 3.1-2 and 3.1-3 and which are provided in multiple variations. In a first embodiment, the second part 3.1-2 is constructed analogously to the regulating unit 3.0, but without a recess. The second part 3.1-2 has, at one end of the elongate orifice, a perpendicular end plate with a threaded bore. Said end plate is attached to the second strip on a side situated opposite the first strip provided with only one orifice, and at another end. The first part 3.1-1 is composed of a strip which is elongate in the second spatial direction and which has the dimensions and form of an element of class 1.0 “single bar elements”, which strip has only two orifices, formed at two ends, in a first spatial direction, furthermore has a plate attached perpendicularly on a side, facing away from a first end of the strip, of a first orifice, and also has a third part 3.1-3 which is attached parallel to the elongate strip and which is located in a form-fitting manner in a third spatial direction by means of the elongate strip and which is spaced apart from the latter in the first spatial direction by the wall thickness of the second part 3.1-2 and which has a cuboidal structure. Said perpendicularly attached plate has substantially square side surfaces and a wall thickness analogous to the other components and also a centrally formed bore for receiving a setting screw. The cuboidal structure is composed of a trough-shaped basic body whose base points away from the elongate strip in the first spatial direction and whose end is rounded analogously to, and in a projection in an accurately fitting manner with respect to, the parallel elongate strip. At the rounded end of the trough-shaped basic body, the base has a bore, formed coaxially with respect to a second orifice of the elongate strip, in a first spatial direction, for receiving a clamping screw. Said second orifice of the elongate strip has an internal thread into which an external thread of the clamping screw engages, such that the trough-shaped basic body can be screwed against the elongate strip. By means of the clamping screw, therefore, it is possible for the second part 3.1-2 to be fixedly clamped between the third part 3.1-3 and the elongate strip of the first part 3.1-1.

The setting screw is rotatable and is inserted, fixed axially by means of a pin (not visible), in the perpendicular plate and comprises, adjacent to the perpendicular plate, a nut which is fixedly connected to the setting screw. With respect to the nut on the opposite side of the perpendicular plate, the threaded rod of the setting screw engages into the thread of the end plate. In this way, the first part 3.1-1 can be moved in a continuously variable manner relative to the second part 3.1-2 by means of a rotation of the setting screw. The two parts 3.1-1, 3.1-2 can be fixed with respect to one another by means of the clamping screw, which prevents a rotation of the setting screw and movement of the two parts 3.1-1 and 3.1-2 relative to one another, and fixes the distance between the orifices situated at the opposite ends of the two parts 3.1-1, 3.1-2. The spacing between the orifice of the first part 3.1-1 and the orifice of the second part 3.1-2 can be preset by means of a gauge and subsequently fixed by means of the clamping screw.

As further possible embodiments, elements of class 3.1 “linear setting unit” are provided which differ substantially in terms of the number of orifices and by the lack of cranked portion in the second part 3.1-2. In variants, the second part 3.1-2 may be provided with two orifices. As further variants, a cranked portion may be provided between the region with one or two orifices and the region with the elongate orifice, whereby the two parts 3.1-1, 3.1-2 can be screwed together either in the same plane or with an offset by a thickness of a bar element 1.0. The first part 3.1-1 may likewise have two orifices. The combination of these variants of the two parts 3.1-1 and 3.1-2 basically yields eight different embodiments. Four of these embodiments are illustrated in FIGS. 3a, 3b. Two of these embodiments have no cranked portion and comprise one orifice on the second part and one or two orifices respectively on the second part. The other two embodiments differ from those described above in that they have a cranked portion.

Also shown in FIGS. 3a, 3b is an element of class 3.2 “angular regulating units” which is constructed analogously to the illustrated elements of class 3.0 “linear regulating unit”, with the exception that the first strip is formed, in the region of the orifice, in the manner of elements of class 2.0 “linear struts”.

As further exemplary embodiments, FIGS. 3a, 3b illustrates elements from class 3.3 “angular setting unit” which are constructed analogously to the elements of class 3.1 “linear setting unit”, with the same exception that the element of class 3.2 “angular regulating unit” has, in contrast, the element of class 3.0 “linear regulating unit”. The angular setting units may be provided in the same variations with regard to the number of orifices of the first and second parts and with regard to the design of a shoulder as the linear setting unit.

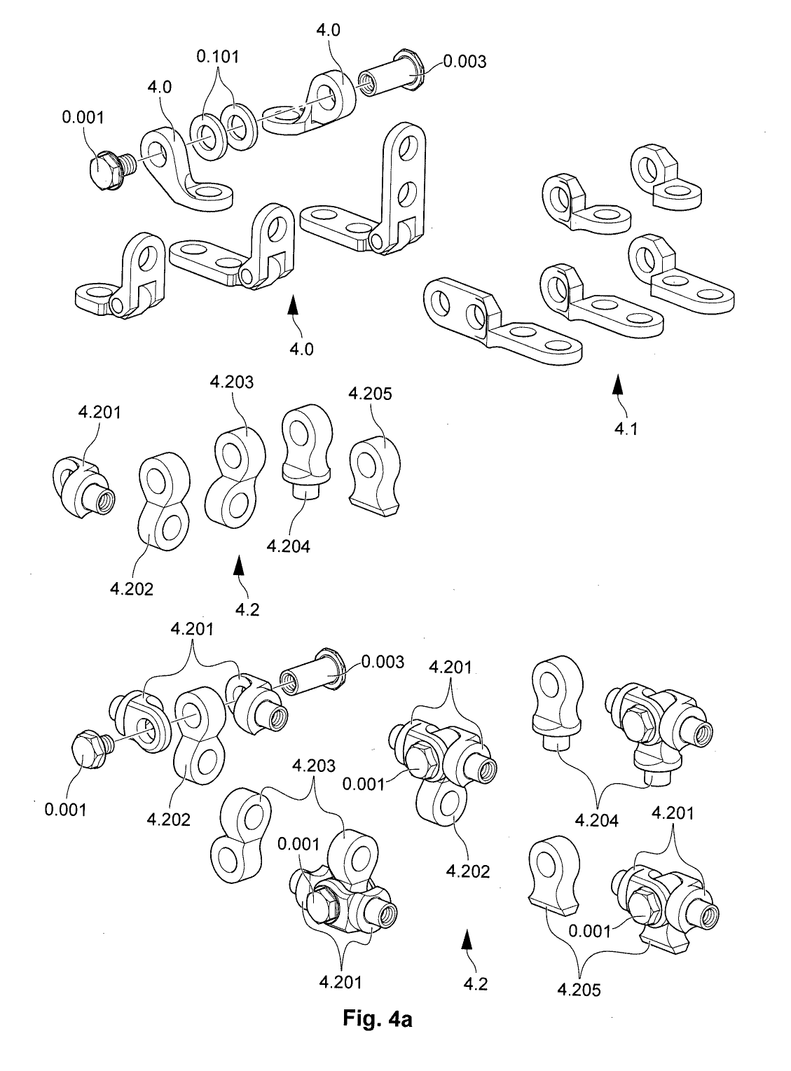

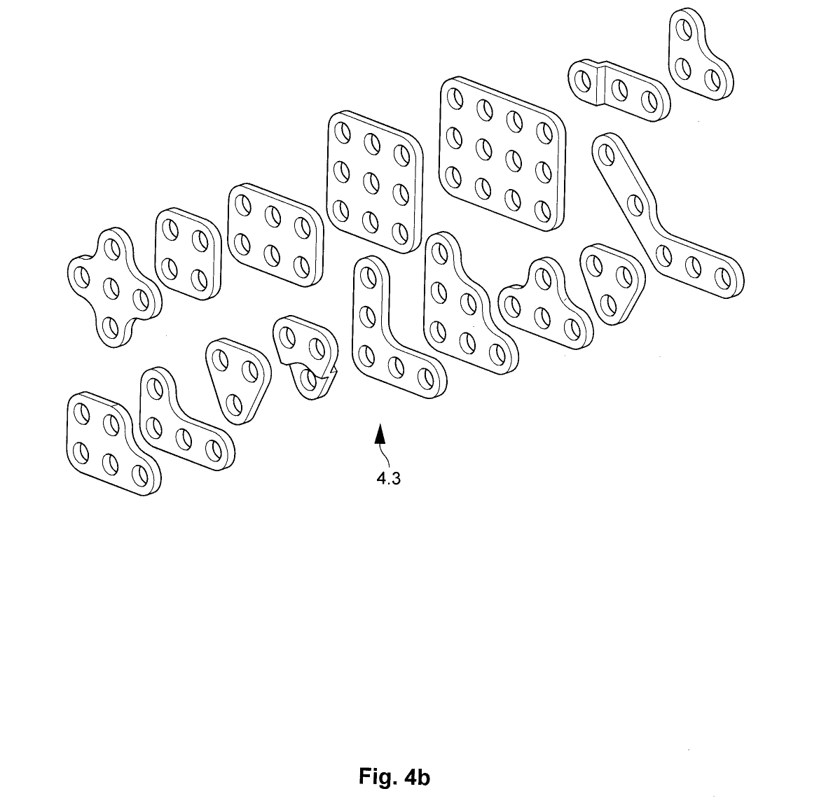

FIGS. 4a, 4b illustrates exemplary embodiments of the lightweight embodiment of elements of classes 4.0 “hinge elements”, 4.1 “twist elements”, 4.2 “joint elements” and 4.3 “spider elements”.

Elements of class 4.0 “hinge elements” are composed of two substantially identical wing plates designed in the manner of elements of class 1.0 “single bar elements”, wherein both wing plates have either one or two orifices connected at in each case one end surface by a hinge. In a further embodiment, a wing plate of said type may have one orifice and the second wing plate may have two orifices.

Further elements of class 4.0 “hinge elements” are composed of two wing parts produced in each case from two plates standing at right angles to one another, wherein said plates have in each case one orifice of standard diameter. Said plates have as small as possible a side surface such that they can have in each case a single orifice, and said plates have the same wall thickness as the elements of class 1.0 “single bar elements”. In said wing parts, the two plates are in each case arranged relative to one another such that the combination of two wing parts by the connection of in each case one of the orifices of the two wing parts by means of a cap screw 0.001 and a sleeve nut 0.003 the other orifices of the two wing parts may lie on opposite sides of said screw and coaxially. A spacer disc 0.102 may be provided between the two wing parts to be screwed together. Said spacer disc may be provided in a variety of thicknesses, and may also be used in some other way. The inner diameter of the spacer discs 0.102 corresponds in each case to the outer diameter of the sleeve nut 0.002.

Likewise shown in FIGS. 4a, 4b are elements from the class 4.1 “twist elements” which are composed in each case of two plates which stand on one another with their sides at right angles and which are dimensioned as per the elements of class 1.0 “bar elements”, which plates both have either one or two orifices. Said two plates are fastened with end surfaces to one another such that one side of a first plate lies in the same plane of a surface of a second plate, and at the same time a surface of the first plate lies in the same plane as a side of the second plate.

Also illustrated in FIGS. 4a, 4b are elements from class 4.2 “joint elements” which can be assembled to form cardan joints. A first embodiment 4.203 of the joint elements 4.2, formed as double joint element L12.5-offset, and a second embodiment 4.202, composed of two wing parts which are at right angles to one another and which have in each case one orifice. The wing parts may be arranged axially offset 4.203 or centrally 4.202, wherein a wing orifice axis of one wing and a wing orifice radius of the other wing intersect at right angles outside an orifice in the case of the axially offset version, and within an orifice in the central version. A further embodiment 4.201 formed as a revolute joint element is composed of a single wing part with one orifice, wherein the wing part is connected, at right angles to the orifice, to a sleeve with an internal thread, wherein the sleeve is constructed correspondingly to the sleeve nut. The sleeve may be arranged axially offset 4.201 or centrally 4.204 with respect to the orifice, wherein the sleeve axis and the orifice axis intersect in any case. A further embodiment 4.205 formed as a welded joint element is in turn composed of a single wing, wherein a region suitable for welding is provided tangentially with respect to the orifice. In the present exemplary embodiments, in each case between two joint elements of the second embodiment 4.201, a double joint element 4.202, a sleeve joint element 4.204 or a welded joint element 4.205 is pushed via the orifices thereof onto a sleeve nut 0.003 and subsequently fixed by means of a cap screw 0.001. The different embodiments may however also be combined in some other way.

Also illustrated in FIGS. 4a, 4b are elements from class 4.3 “spider elements” which are all composed of plates or strips with in each case two sides and two surfaces, analogously to the elements of classes 1.0 “single bar elements” and 1.1 “double bar elements”. The geometric shapes of the side surfaces of said elements are highly diverse and range from square or cuboidal plates with between four and nine symmetrically formed orifices to a cross-shaped plate with four arms of equal length and standing at right angles to one another, said cross-shaped plate having an orifice formed in the centre and in each case one further orifice formed in each arm. A further embodiment of an element of this class has a T shape formed by cutting off one arm of the cross-shaped element. Another embodiment again has side surfaces in the form of isosceles triangles with three orifices arranged symmetrically in the form of a regular triangle, wherein in one embodiment, one of the orifices is offset by the material thickness of the plate. Other embodiments are of L-shaped form with two arms standing at right angles to one another and have an orifice in the region of a connection of said two arms, while the two arms have one or two orifices. Yet another embodiment has two parallel rows of orifices, wherein a first row has three orifices and a second row has two orifices. Also illustrated is a combination of a bar element 1.0 with three orifices and a linear strut 2.0 with three orifices, wherein one of the orifices is common to both elements which are at an angle of approximately 45° relative to one another. The two parallel rows are arranged analogously to the two rows of the elements 1.1 “double bar elements”, and the plate has a geometric form selected so as to yield a minimal side surface. In general, said elements may have a cranked portion at any desired location, wherein a part of the element lies in one plane and that part of the element which is connected via the cranked portion lies in a parallel offset plane.

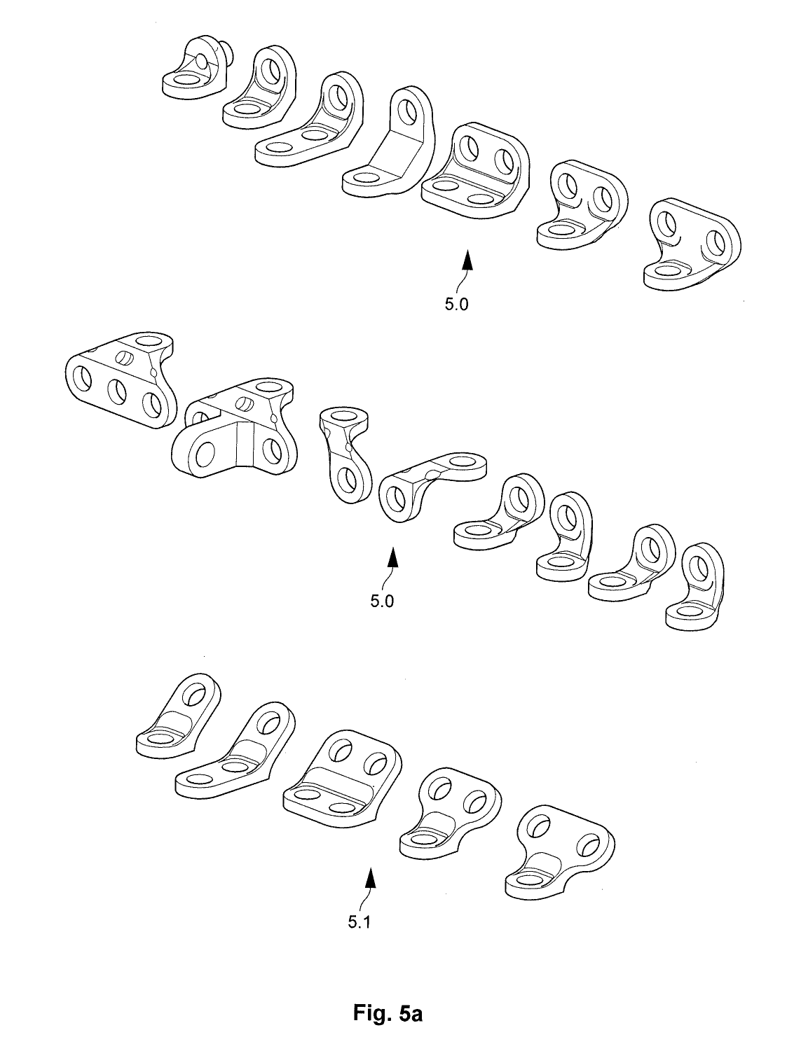

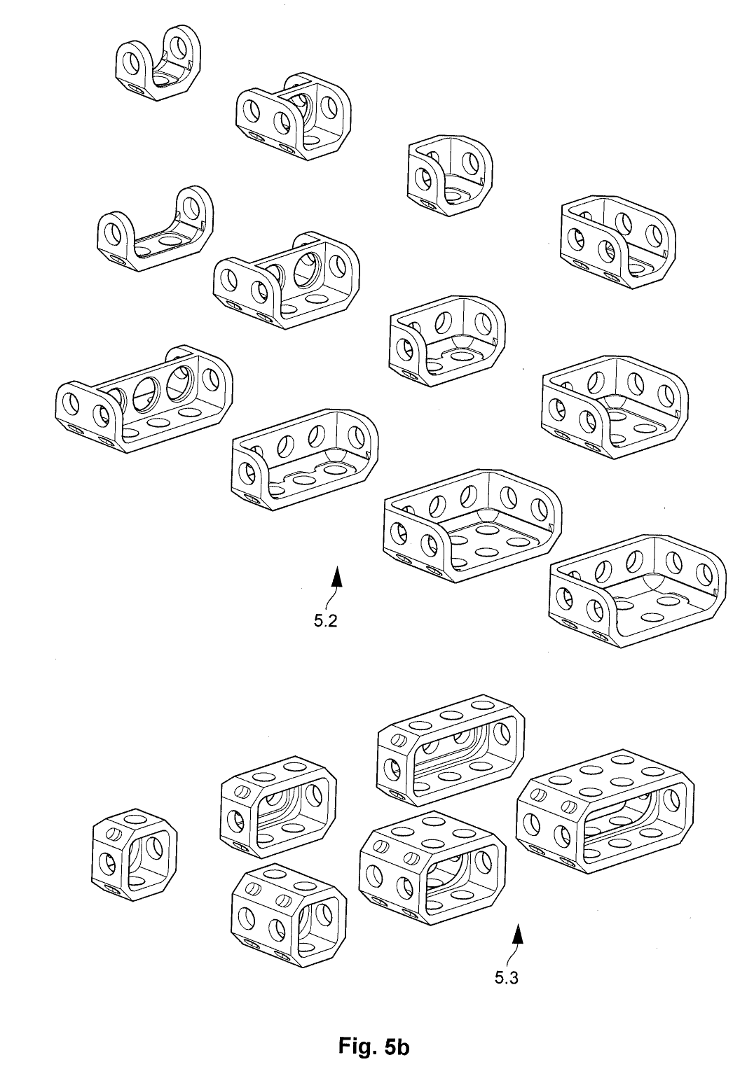

FIGS. 5a, 5b shows exemplary embodiment of the lightweight embodiment of elements of classes 5.0 “L90° angle elements”, 5.1 “L45° angle elements”, 5.2 “U elements” and 5.3 “box elements”.

An element of class 5.0 “L90° angle elements” is composed of two strips which are produced analogously to the strips of elements of class 1.0 “single bar elements” and which stand at right angles to one another and, with respect to edge centres, are positioned and fixed symmetrically with respect to one another such that they have an edge of the respective side in common. The strips have in each case between one and three orifices, the shape and formation of which is identical to the orifices of the elements of class 1.0 “single bar elements”. Possible combinations of these strips yield numerous embodiments, a few of which are illustrated. In variants, a sleeve corresponding to the cap screw may be provided instead of the orifice.

A specific embodiment has a first strip with one orifice and a second strip with two orifices, the edge spacing of which orifices corresponds to the edge spacing of orifices of the elements of class 2.0 “linear struts”. A further specific embodiment has two strips which stand at right angles to one another and which have in each case one orifice, wherein surfaces and end surfaces of the two strips lie parallel, and a plate of the same dimensions and design of the strips and without an orifice, wherein the two strips are spaced apart in a first and a third spatial direction by said plate; the sides of said plate enclose in each case an angle of 45° with the sides of the strips. Also illustrated are embodiments which are designed as per the elements of class 2.0 and which have two orifices, wherein the orifice axes are perpendicular to one another and comprise two orifices, wherein the orifice axes are perpendicular and skewed relative to one another. Yet a further embodiment is based on an embodiment whose strips have a single orifice and three orifices, but a central orifice of the strip with three orifices, the axes of which point in a first spatial direction, is replaced by a further strip which is attached at right angles and so as to point towards a side opposite the strip with a single orifice whose axis lies in a third spatial direction, said further strip having a single orifice whose axis lies in a second spatial direction. The latter further strip is produced analogously to the strips of the elements of class 1.0 “single bar elements”, but has a slightly greater wall thickness.

Likewise illustrated in FIGS. 5a, 5b are elements from class 5.1 “45° angle elements” which are produced analogously to the elements of class 5.0 “90° angle elements” but whose strips enclose an internal angle of 135° rather than being at right angles to one another.

Also illustrated in FIGS. 5a, 5b are elements from class 5.2 “U elements” which are composed of three strips formed and produced as per the strips of the elements of class 1.0 “single bar elements” or of class 1.1 “double-row bar elements”, which strips stand in each case perpendicular to one another and are arranged in a U shape, having one strip in a first spatial direction and two strips in a second spatial direction. Here, the two strips in the second spatial direction have in each case one or two orifices, wherein as a result of the arrangement of the strips, said orifices lie coaxially in pairs, whereas the strip in the first spatial direction is of single-row design and has one or two orifices, or is of double-row design, and has a total of two, four or six orifices. In the double-row embodiments, the two parallel strips are connected centrally by means of a strut.

Instead of one strip in the first spatial direction, it is also possible for two strips which are perpendicular to one another to be provided in the first spatial direction, such that a cuboid is formed in which two mutually adjacent side surfaces are omitted. The parallel strips may have one or two orifices. The two further strips may each be of single-row design with one to three orifices, or one may be of single-row design with one to three orifices, and the other may be of double-row design with a total of two, four or six orifices. Four orifices of a strip with three adjacent strips may also be arranged in a rhomboidal pattern, wherein in a U-shaped framing, the two adjacent strips have in each case two orifices whose orifice axes do not intersect two of the orifice axes of the rhomboidally arranged orifices, and the enclosed strip of the U-shaped framing has three orifices whose orifice axes intersect in each case at least one orifice axis of the rhomboidally arranged orifices. Said elements are not strutted.

FIGS. 5a, 5b also shows exemplary embodiments of class 5.3 “box elements” which are composed of four size plates corresponding to the form and manner of production of elements of classes 1.0 “single bar elements” or 1.1 “double bar elements” and which have one or two rows of one to three orifices. Such an element has in each case two first identical side plates with one or two orifices and two second identical side plates with at least one orifice. The two first side plates are arranged parallel and are fastened at right angles to the two second side plates, such that the orifices of the two second side plates are likewise coaxial with respect to one another. Also connected at right angles to the side plates is a cover plate which, in accordance with the dimensions of the side plates, has one row of one to three orifices. It is however not imperatively necessary for a cover plate to be provided.

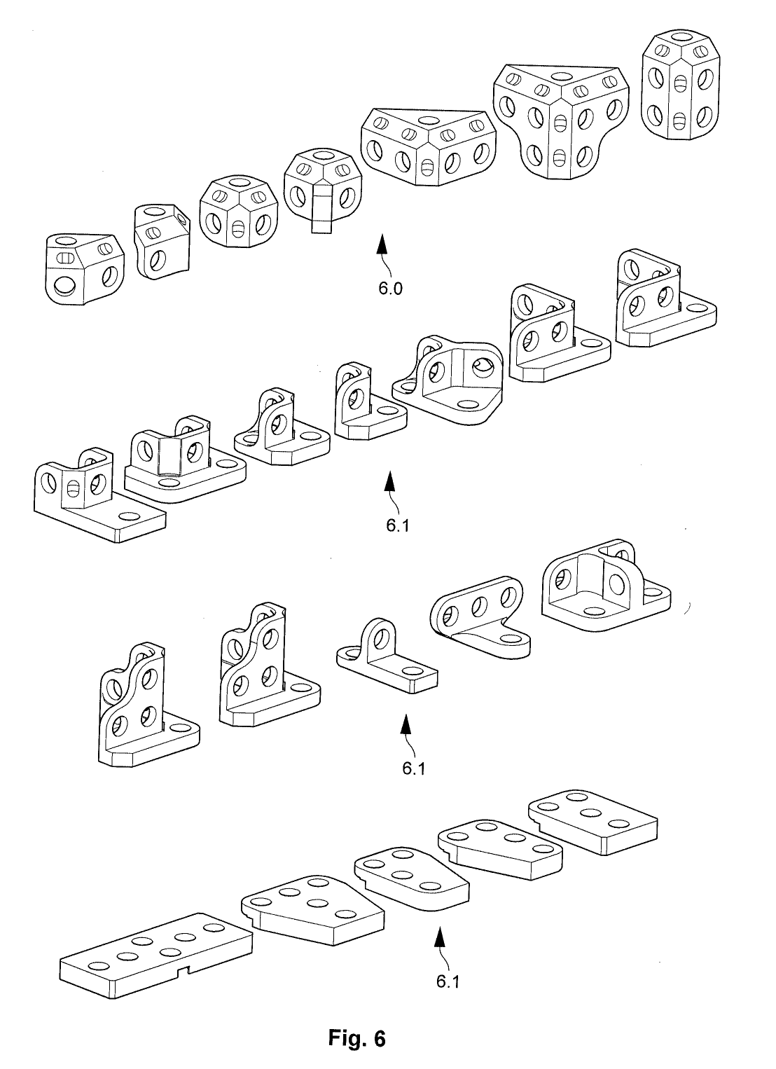

FIG. 6 shows exemplary embodiments of classes 6.0 “corner elements” and 6.1 “support elements”.

Elements of class 6.0 “corner elements” of a first component are composed of three side strips formed analogously in terms of dimensions and production to the elements of class 1.0 “single bar elements” with one or two orifices. Here, two of the three side strips are of identical form and a third side strip has a single orifice formed in the centre of the side. All three of said side strips are combined with one another by the connection of in each case one edge such that surfaces or end surfaces of two mutually adjacent side strips stand at right angles to and flush with one another, wherein identically designed side strips are fastened symmetrically to one another.

In the embodiment in which the two side strips have in each case two orifices and are attached to one another by the connection of end surfaces, a third of the three side strips has, in contrast to the abovementioned design, side surfaces in the form of an isosceles triangle, wherein equal-sided edges are of the same length as side surfaces of the side strips. In a further embodiment, the two side strips have in each case three orifices arranged in the form of an isosceles triangle.

A further embodiment has, in addition to the three side strips which in this embodiment have in each case only one orifice, a fourth strip which is formed analogously to the other three side strips. Said fourth side strip is attached with one of its surfaces or end surfaces between the first and second side strips, such that the sides thereof enclose in each case an angle of 135° with the sides of the first and second side strips, and said side stands at right angles to the third side strip.

Also illustrated in FIG. 6 are elements of class 6.0 “corner elements” which are produced from three strips with in each case one orifice, said strips being produced substantially analogously to the elements of class 1.0 “single bar elements”. A first of said three strips has side surfaces which are enlarged to a trapezoidal shape and which have two adjacent right angles, an internal angle of 45° and a further internal angle of 135°, while a second of said three strips has a correspondingly greater length. In this way, interconnection is possible as follows: the first of the three strips is connected, along a shorter one of the two mutually parallel edges, at right angles to an edge of a third of said three strips, such that axes of the respective orifices intersect at right angles at a point. The second of said three strips is then attached by the connection of one of the longer edges to a longest edge of the first of the three strips and the connection of a shorter edge to an edge of the third of said three strips, such that said second strip stands at right angles to the first of said three strips and encloses an internal angle of 135° with the third of said three strips, wherein the orifice situated in said second of said three strips is situated on the end facing away from the third of said three strips.

Also shown in FIG. 6 are elements of class 6.1, “support elements” in a variety of embodiments.

The “support elements” 6.1 basically have in each case one base plate with at least one orifice, wherein the base plate may be of substantially any desired shape, for example square, rectangular, triangular, trapezoidal etc., wherein concave shapes, such as for example an L shape and the like, are also conceivable. Connected to the base plate are elements which stand in each case perpendicular thereto and which may be composed of one or more single-row bar elements 1.0 (wherein double-row bar elements may also be provided in regions) which may assume a U shape (see U elements 5.2), a T shape, a Y shape, an L shape etc. Some “support elements” 6.1 are described in more detail below.

In two first embodiments, an element of said type is composed of a trapezoidal plate, wherein the trapezium has two adjacent right angles, which plate has four orifices of standard diameter and standard edge spacing, said orifices being formed at right angles to sides of the plate. Said four orifices are arranged in an L shape as a combination of one row with three orifices and one row with two orifices, wherein said two rows have one orifice in common. The corners of said plate are rounded in the region of the orifices situated there, similarly to the corners of the elements of class 1.1 “double bar elements”, and the plate has a reduced wall thickness in the region of the row with two orifices. Since said reduction in wall thickness may be formed on two different sides of the plate, this yields two possible embodiments.

In a second embodiment which is composed of a plate in the form of an isosceles triangle, orifices of standard diameter and standard edge spacing are formed in a T-shape with axes at right angles to sides of the plate, wherein three orifices lie in a first row along an edge adjoining equal sides, and two orifices lie along a second row extending away at right angles from a central of the three orifices. This embodiment has, analogously to the first embodiment, a reduced wall thickness along the edge.

The plates may have a cutout on one side in the region of one or more orifices, such that the plate can rest flat on the ground even when a screw is arranged, with the screw head directed towards the ground, in an orifice.

A third embodiment is composed of four strips formed and produced analogously to the elements of class 1.0 “single bar elements”, wherein two of said four strips have two orifices which however have a spacing increased by the wall thickness of a third of said four strips, and both the third and also a fourth of said four strips have a single orifice. In the region of each orifice, in each case one of the corners, in the case of the fourth of said four strips two adjacent corners, are rounded; in the case of the two of said four strips, rounded corners are adjacent. Said two of the four strips are combined, standing at right angles on one another, by the connection of in each case one edge facing away from the rounded corners. A third of said four strips is attached at right angles to, and in the centre of, both of the two of said four strips, wherein the rounded corner points away from both of the two of said four strips. A fourth of said four strips is attached, on a side, which faces away from the third of said four strips, of a first of the two of said four strips, in the centre of the edge as an extension of the third strip.

In a fourth embodiment, an element of said type is composed of two strips which are connected to one another with their sides at right angles to one another. A first strip is identical to the strips with three orifices of class 1.0 “single bar elements”, while a second strip is produced analogously but is provided only with two orifices formed at two ends of the strip. The first strip is fixed with one of its surfaces at right angles in the centre of one side of the second strip, such that an axis of a central orifice of the third strip intersects axes of the orifices of the second strip at right angles.

In a fifth embodiment which is of analogous design to the fourth embodiment, the length of a first strip is reduced to such an extent that it comprises a single orifice.

A sixth embodiment is formed from two side strips which are analogous in form and design to the elements of class 1.0 “single bar elements” and from a base plate. The two side strips have either one or two orifices and also in each case one rounded corner in the region of the orifice, and are connected at right angles by the connection of in each case one end surface facing away from the rounded corner. The base plate is of V-shaped design with two identical legs and has, in the region of a connection of said two legs, an orifice of standard diameter, the axis of which orifice is at right angles to the plane formed by the two legs. The two legs are at right angles to one another with respect to mutually adjacent inner surfaces, and taper away from the orifice such that they have a square cross-sectional area at outer ends. The connected side strips are fixed at right angles to said base plate formed in this way, such that mutually adjacent inner sides of the side strips adjoin the adjacent inner surfaces of the base plate in a flush manner, and the outer ends of the base plate meet outer ends of the side strips with an accurate fit.

Likewise illustrated is a seventh embodiment which is composed of three elongate side strips and two base plates. All three of said side strips are formed substantially analogously to the elements of class 1.0 “single bar elements” with a single orifice, wherein a first and a second of said side strips have, in contrast thereto, an increased width and a third of said side strips has, in contrast thereto, no orifice but instead an increased wall thickness and a likewise increased width. The base plates have the same wall thickness as the first side strip, are produced in the shape of a kite with one of the internal angles being 120°, and have an orifice of standard diameter in a corner situated opposite the 120° angle. Furthermore, edges of the kite adjoining the 120° angle are of the same length as a side of the side surfaces. The three side strips are connected to one another at end surfaces such that their surfaces form a plane and enclose between them in each case an angle of 120°. Here, the first and second side surfaces are located such that axes of their orifices intersect at a point and the third side surface is situated in between. At an end facing away from the orifices of the first and second side strips, the base plates are attached such that the third side strip lies between the two base plates, wherein an axis of the orifices formed therein is in each case parallel to the sides of the two adjoining side surfaces.

The support elements 6.1 may for example also be used for mounting a workpiece carrier plate 8.0 (see below) as a cover plate on a structure. The expression “support element” should therefore not be understood as a limitation of the use thereof.

FIG. 7 shows exemplary embodiments of elements of classes 7.0 “90° frame”, 7.1 “45° frame”, 7.2 “90°×45°+2L25 frame”, 7.3 “90°×45°+L25 frame” and 7.4 “90°×45°+2L12.5 frame”. All the elements of said classes are composed of a frame whose frame strips lying in a plane correspond analogously in form and design to the elements of classes 1.0 “single bar elements” and/or 2.0 “linear struts” including orifices formed therein. Here, the geometric form of the frame is such that axes of all of the orifices formed therein lie parallel to one another, and orifices in corners of the frame are common to both frame strips which meet there.

The elements of class 7.0 “90° frame” have four frame strips which are all produced analogously to the elements of class 1.0 “single bar elements” and which have between three and eleven orifices, wherein two of the four frame strips are always of identical design and form opposite frame strips of the frame. In each case two frame strips adjoining one another stand perpendicular on one another, thus forming a frame in the form of a rectangle.

Also illustrated in FIG. 7 are elements of class 7.1 “45° frame” which are formed from three frame strips which form a right-angled isosceles triangle. Two of said frame strips which form cathetuses of the triangle are produced analogously to the elements of class 1.0 “single bar elements”, while a third frame strip which forms the hypotenuse of the triangle is formed analogously to the elements of class 2.0 “linear struts”. The combination of the three frame strips is analogous to the elements of class 7.0 “90° frame”.

FIG. 7 likewise shows elements of class 7.2 “90°×45°+2L25 frame”, the frames of which are formed from five frame strips. Here, a first and a second pair of frame strips are produced in each case identically and are formed analogously to the elements of class 1.0 “single bar elements”, while a fifth frame strip is designed as per the elements of class 2.0 “linear struts”. Frame strips of the second pair have three orifices. The first pair of frame strips are at right angles to one another and form an L shape; frame strips of the second pair stand in each case at right angles on ends of the L shape of the first pair. The fifth frame strip forms a connection between the ends of the frame strips of the second pair and close the frame, wherein said fifth frame strip encloses an angle of in each case 135° with the frame strips which form the second pair of frame strips.

FIG. 7 furthermore shows elements of class 7.3 “90°×45°+L25 frame”, the frames of which are formed from four frame strips. Here, a first frame strip with n orifices and a second frame strip with n+1 orifices form a right angle. Adjoining the first frame strip at right angles is a third frame strip which comprises two orifices, wherein said third frame strip shares one orifice with the first frame strip. The fourth frame strip connects the two ends of the above-described shape, whereby substantially a closed triangle is formed.

FIG. 7 finally shows elements of class 7.4 “90°×45°+2L12.5 frame”, the frames of which are formed from five frame strips. Here, a first and a second pair of frame strips are produced in each case identically and analogously to the elements of class 1.0 “single bar elements”, while a fifth frame strip is designed as per the elements of class 2.0 “linear struts”. Frame strips of the second pair have two orifices. The first pair of frame strips stand at right angles on one another and form an L shape; frame strips of the second pair stand in each case at right angles on ends of the L shape of the first pair. The fifth frame strip forms a connection between ends of the frame strips of the second pair and closes the frame, wherein said fifth frame strip encloses an angle of in each case 135° with the frame strips which form the second pair of frame strips.

FIG. 8 illustrates exemplary embodiments of elements of class 8.0 “workpiece carrier plates”. These are composed of a cuboidal plate. In the corners of the plate there are formed orifices of standard diameter, the axes of which orifices lie in the third spatial direction. The dimensions of the plates are substantially freely selectable and may in particular be adapted to the respective application. The figure shows only a few examples for illustration. In the first embodiment, the plates have in each case a reduced material thickness in the region of the orifices. The reduction in material thickness may in particular be such that a surface of a screw head of a fastening screw can lie flush with the plane of the plate. Such workpiece carrier plates are provided for machining and adapting to structural conditions at the installation side. It is however clear to a person skilled in the art that the orifices, or certain orifices, in the corners may also be produced by the user, whereby a plate of said type may also be provided without orifices or with fewer orifices.

FIG. 9 shows exemplary embodiments of class 9.0 “T-groove rails”. Such T-groove rails are composed of a base strip and of two identical parallel side strips which stand at right angles on the base strip, so as to yield a U-shaped overall cross section. Both the base strip and side strips have approximately equal-sized cross-sectional areas and the same wall thickness as elements of class 1.0 “single bar elements”. Furthermore, 2 to 10 orifices, depending on the embodiment, are formed in the base strip analogously to the elements of class 1.0 “single bar elements”. The T-groove rails may however also have more than 10 orifices. The side strips furthermore have, at their ends opposite the base strip, flange-like extensions which are directed towards one another and formed parallel to the base strip. FIG. 9 also shows a sleeve nut with a T-groove head in the short embodiment 0.004 and the long embodiment 0.005. The heads of said sleeve nuts are of trapezoidal form, such that they can be inserted from above into the T-shaped groove rail 9.0. By being rotated about its longitudinal axis, the head of the sleeve nut can engage behind the flange-like extension, such that a component can be screwed to the T-groove rail 9.0 by means of the cap screw 0.001.

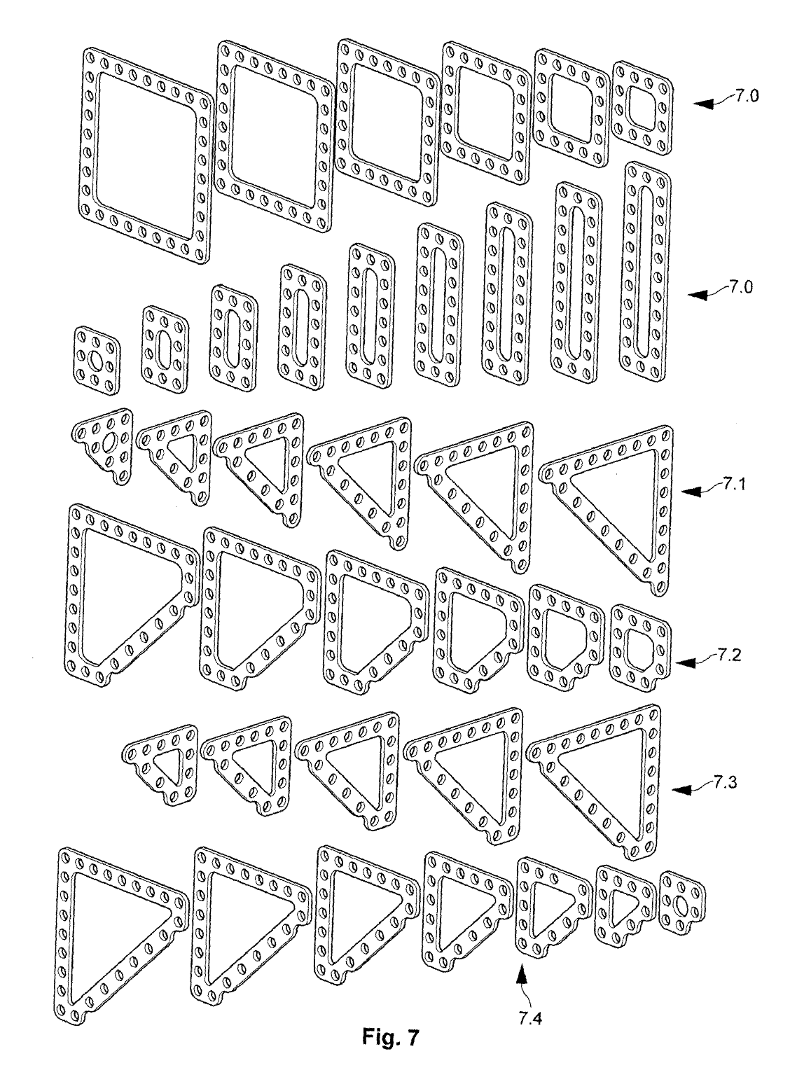

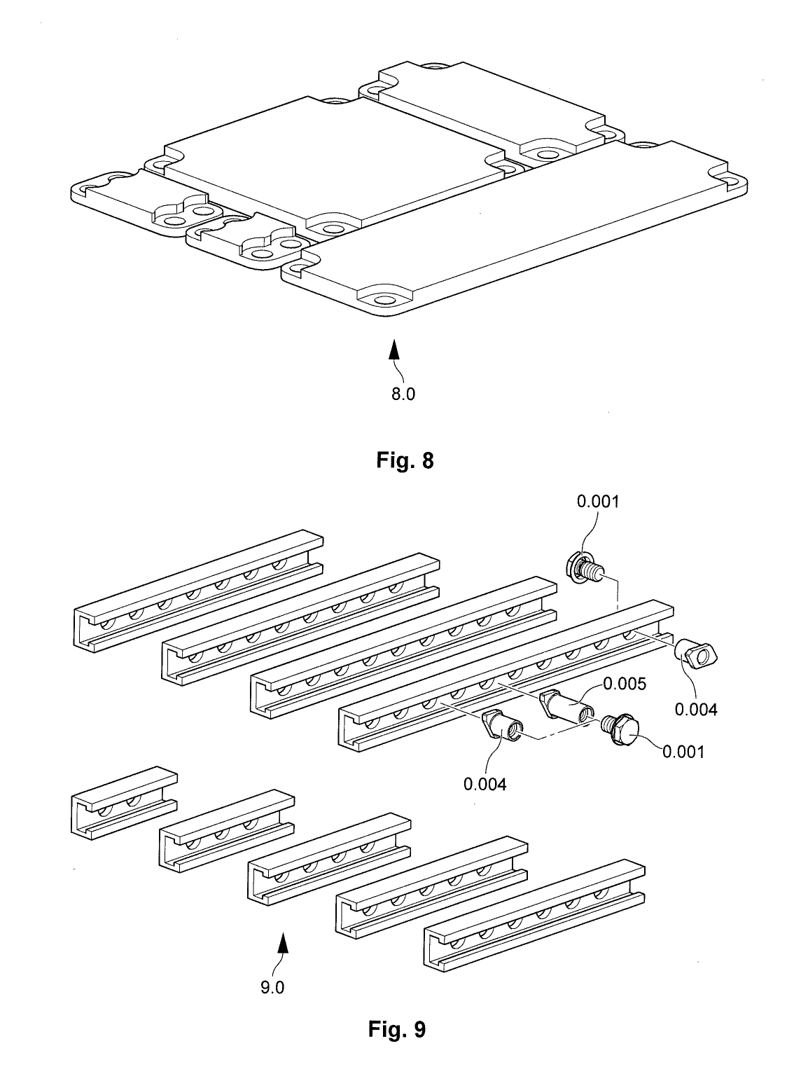

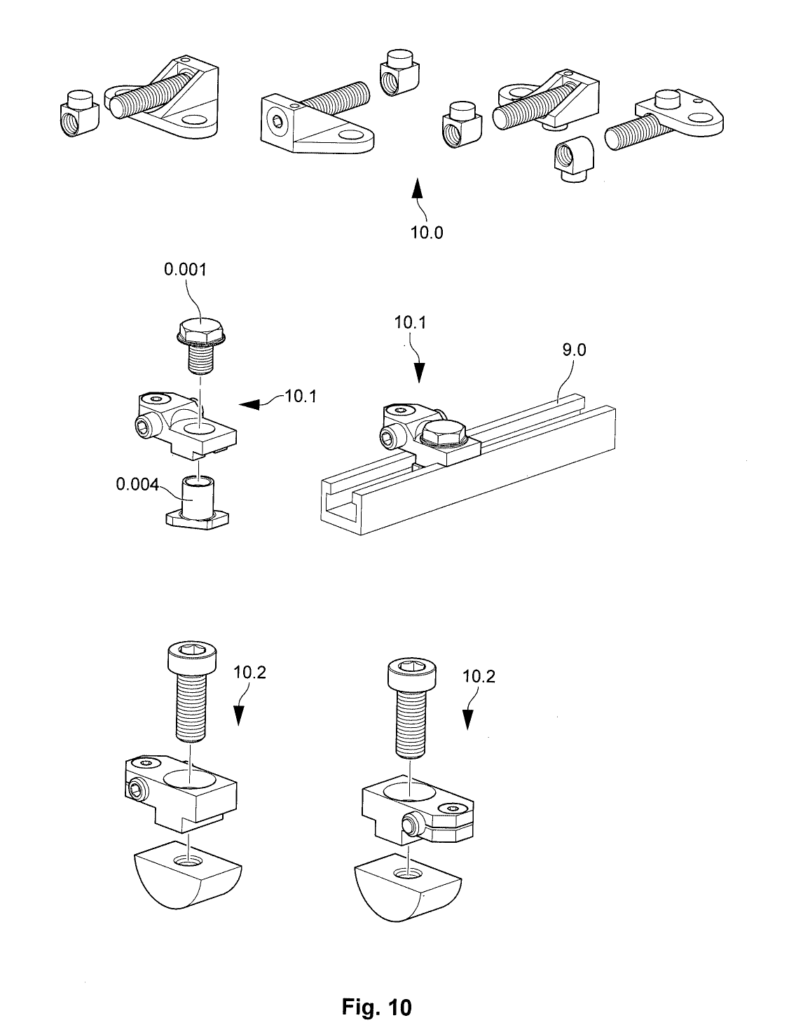

FIG. 10 illustrates exemplary embodiments of the lightweight embodiment of elements of classes 10.0 “readjustment units, linear”, 10.1 “readjustment units, lateral” and 10.2 “readjustment units, lateral ‘special’”.

Elements of the former class 10.0 “readjustment units, linear” are composed of a substantially cuboidal holder with a central bore formed in the direction of greatest wall thickness and with a cutout which is formed from an outer side in the direction of the threaded bore and which has a U-shaped cross section. Said cutout has a greater diameter than the bore and is formed such that the cross section of the resulting holder in the region of the cutout is likewise U-shaped at right angles to the direction of the bore. Said holder furthermore has a hole plate which is attached laterally at right angles and which points away from the holder and which has a wall thickness analogous to the elements of class 1.0 “single bar elements”, which hole plate has a centrally formed orifice of known diameter, wherein an axis of said orifice is at right angles to an axis of the bore. The holder furthermore has a screw, which fits into the bore and which has a hexagon head which is held in a rotatable and axially fixed manner in the bore, with an associated threaded nut, wherein the latter has the shape of the cutout, as a result of which said threaded nut can be pulled into the cutout of the holder by turning the screw. On a non-curved lateral surface, the threaded nut has a cylindrical peg mounted in the centre of the surface, the axis of symmetry of which peg is at right angles to the threaded bore, and which peg has a diameter identical to the orifices formed in the elements of class 1.0 “single bar elements”. The former class likewise includes embodiments which, in contrast to the above description, can be readjusted by means of an Allen screw. Furthermore, depending on the embodiment, the holder comprises one or two hole plates. On the underside, the holder of the embodiment with one hole plate has one peg as described above.

Likewise illustrated in FIG. 10 are elements from class 10.1 “readjustment units, lateral” which are composed of a cuboidal basic body which has a smallest wall thickness in a third spatial direction, a medium wall thickness in a second spatial direction and a greatest wall thickness in a first spatial direction. Here, the smallest wall thickness corresponds approximately to the wall thickness of the elements of class 1.0 “single bar elements”, while the greatest wall thickness corresponds approximately to the length of an element of class 1.0 “single bar elements” with two orifices. In the direction of the greatest wall thickness parallel to the medium wall thickness, a cuboidal cutout is formed in the basic body from a first outer side in the centre of that side, the extent of which cutout corresponds precisely to the medium wall thickness in the direction of said wall thickness, amounts to only a few millimetres in the direction of the smallest wall thickness, and makes up approximately one third of the wall thickness of the basic body in the direction of greatest wall thickness. At an inner end, the cutout is closed off by a threaded bore of small diameter which is formed parallel to the medium wall thickness, said threaded bore receiving a first threaded screw with an Allen head. The basic body furthermore has, in the region of said cutout, a threaded bore which is formed at right angles to the cutout and in the direction of the smallest wall thickness, and also a threaded screw which fits into said threaded bore and which has an Allen head and which permits fixing of the first threaded screw by compressing the cuboidal cutout. From a second outer side situated opposite the first outer side, the basic body has a region with a wall thickness reduced approximately by half by a recess at one side in the third spatial direction, the extent of which region in the first spatial direction corresponds to approximately half of the wall thickness in said direction, and also an orifice which is formed approximately centrally in said region in the third spatial direction and which has a standard diameter. In the region of the orifice, the basic body furthermore has a wall thickness increased again in the third spatial direction, this being achieved by means of a cuboidal attachment mounted on the basic body on the outside, the extent of which attachment in the second spatial direction corresponds to the wall thickness of the basic body in said spatial direction. The cuboidal attachment serves for guidance in a T-groove rail 9.0. By means of the orifice with standard diameter, the lateral readjustment units 10.1 can be fixedly screwed by means of a sleeve nut with T-groove head 0.004 and a cap screw 0.001. By means of the threaded screw, it is thus possible for a further component to be readjusted laterally.

A further embodiment of the lateral readjustment unit is the “special” lateral readjustment unit 10.2 which differs from that described above merely in that the cuboidal attachment is designed to be larger, in particular for grooves in accordance with DIN (Deutsches Institut für Normung [German Institute for Standardization]), and in that the screw is formed as a countersunk Allen screw. The readjustment unit may optionally be designed such that the Allen screw can be countersunk or such that the Allen screw cannot be countersunk. This readjustment unit comprises, inserted therein, a groove block which likewise satisfies the corresponding DIN standard. This embodiment is provided for conventional, commercially available groove rails, wherein the prismatic groove rails which have a trapezoidal cross section and which have a bore, said groove rails also being illustrated in FIG. 10, and the corresponding Allen screw are likewise commercially available.

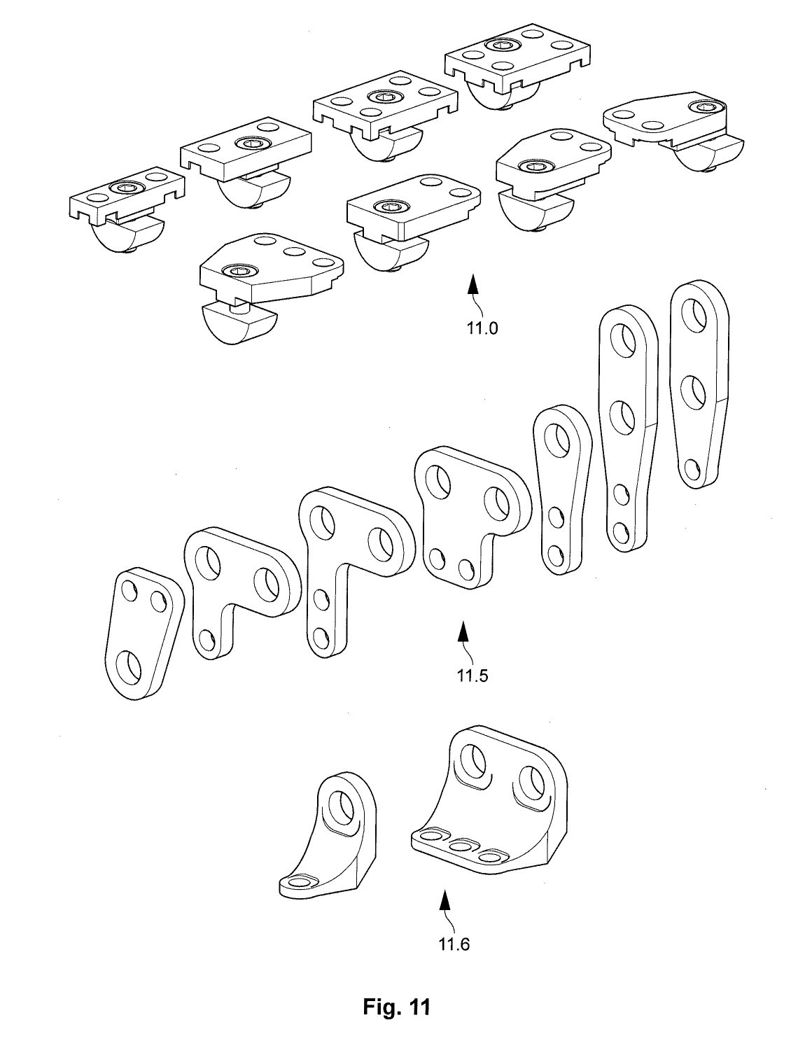

FIG. 11 shows exemplary embodiments of elements of class 11.0 “NS8 Holders” and adapter elements 11.5, 11.6. Here, the base plate has a first wall thickness in a first spatial direction, a second wall thickness in a second spatial direction, and a third wall thickness in a third spatial direction, wherein the third wall thickness approximately corresponds to the wall thickness of an element of class 8.0 “workpiece carrier plates”. The NS8 holders 11.0 comprise a cuboidal attachment which serves as a guide in a commercially available groove rail, for example one which satisfies a DIN standard. The base plate has at least one bore for a commercially available Allen screw, and also a plurality of bores of standard diameter, wherein said bores may also be formed such that the Allen screw head can be countersunk. By means of the Allen screw and the groove rail, the NS8 holder 11.0 can be fastened to a groove rail. The bores of standard diameter thereby serve as adapters, such that components as described above can be fastened to the holder.

The groove block is elongate in the second spatial direction and has a trapezoidal, symmetrical cross-sectional area, wherein an extent in the second spatial direction corresponds to the extent of the attachment of the basic body in the second spatial direction, and the cross-sectional area lies in a plane formed by the first and third spatial directions. Proceeding from a groove block surface which lies in the first and second spatial directions, the groove block has, in the third spatial direction and along an axis of symmetry of the cross-section area, an internal thread whose spacing from one end of the groove block corresponds to a spacing of the bore in the base plate from the second side edge and whose thread diameter corresponds to a thread diameter of the screw. Overall, said first embodiment is constructed as follows: inserting the threaded rod of the screw after the spacer disc into the bore formed in the base plate and in the attachment from that side of the basic body which faces away from the attachment; screwing a thread of the screw into the threaded bore, provided for the purpose, of the base plate, wherein the latter maintains its alignment.

The illustration shows eight possible embodiments which each comprise a DIN groove block, these being formed, in part, similarly to the support elements 6.1. These are likewise of substantially plate-shaped form.

A first embodiment with a rectangular base plate comprises, in the longitudinal direction of the groove rail, two orifices and an interposed Allen screw, wherein the orifices and the Allen screw lie on a straight line.

A second embodiment corresponds substantially to the first, wherein however the two orifices are arranged offset towards the outside in the longitudinal direction of the groove rail.

A third embodiment with a rectangular base plate comprises four orifices arranged in the corners of the base plate, wherein the Allen screw is arranged in the geometric centre of area of the base plate.

A fourth embodiment corresponds substantially to the third embodiment, wherein the Allen screw is arranged centrally in a longitudinal edge region of the base plate.

While it is the case in the above-described embodiments that the Allen screw is arranged in each case centrally with respect to the longitudinal direction of the groove rail, the Allen screws of the following embodiments are arranged in each case in an edge region with respect to said longitudinal direction.

The fifth embodiment has substantially the shape of an isosceles trapezium which comprises three orifices in the region along the side enclosed by the flanks, and comprises an Allen screw centrally in the region of the shorter side enclosed by the flanks.

The sixth embodiment is again of rectangular form with the longer sides parallel to the groove rail and comprises in each case one orifice in the corner regions of a first, shorter side and an Allen screw centrally in the edge region of the second shorter side.

The seventh and eighth embodiments have in each case a convex, pentagonal basic shape with three successive right angles, and differ from one another merely in that they are mirror-symmetrical to one another with respect to the longitudinal direction of the groove rail. Two orifices are situated in each case in the region of two adjacent right angles. The Allen screw is arranged in the region of the third right angle.

FIG. 11 furthermore shows elements from the class 11.5 “linear adapter” and 11.6 “angle adapter”. The linear adapters 11.5 are of similar construction to the spider elements and the angle adapters 11.6 are of similar construction to the angle elements 5.0. In contrast, however, the adapters have different orifice diameters, such that a transition can be created between the large embodiment and the small embodiment of the components.

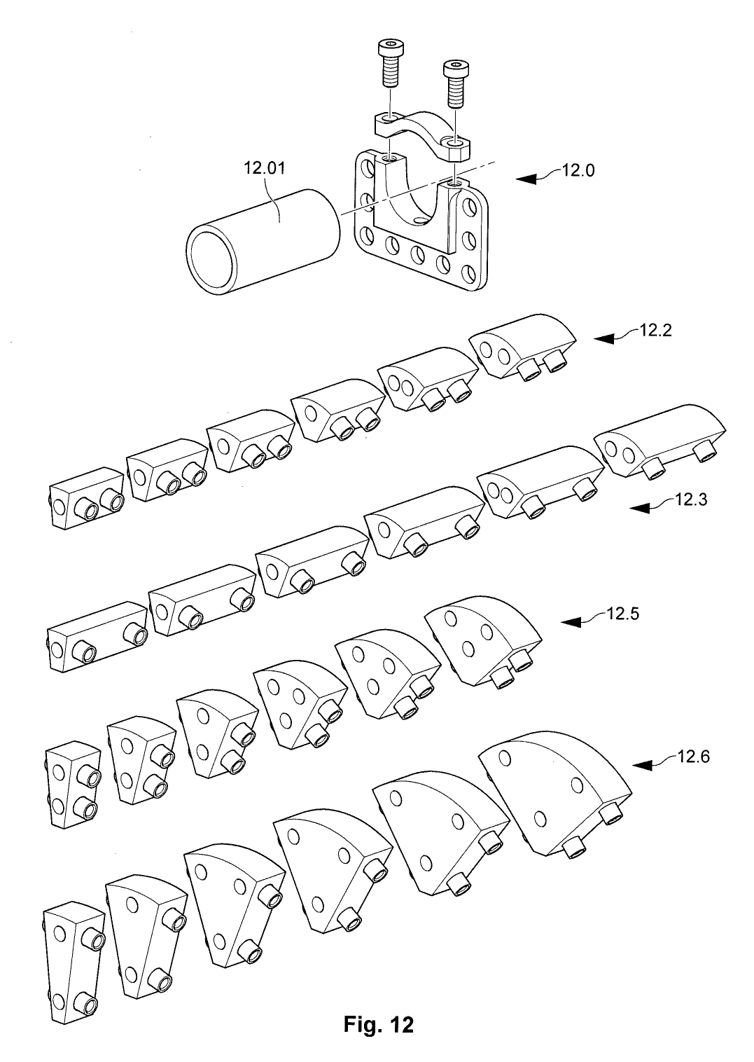

FIG. 12 shows exemplary embodiments of elements from the classes 12.0 “prism module”, 12.01 “standard column”, 12.2 “radial wedge flanges L12.5”, 12.3 “radial wedge flanges L25”, 12.5 “axial wedge flanges L12.5” and 12.6 “axial wedge flanges L25”.

Elements of the former class 12.0 “prism module” comprise a C-shaped base plate in which the two opposite strips have in each case 3 orifices and the strip which connects the two opposite, parallel strips has five orifices. Fitted into said C shape is a U-shaped element which can receive for example a standard column 12.01 mentioned further below. The latter is fixed to the U-shaped element by means of a bracket and two Allen screws. The U-shaped element comprises a bore on the lower part of the receptacle, into which bore a screw can be screwed so as to provide rotational locking of the standard column 12.01 and stiffening of the structure.

FIG. 12 likewise shows elements from class 12.2 “radial wedge flanges L12.5” and from class 12.3 “radial wedge flanges L25”, which are composed of a wedge body and sleeve nuts fastened thereto. The wedge body has a geometric cross-sectional area in the form of a sector cut out from a circular ring disc, wherein an axis of said circular ring disc lies in the second spatial direction. An angle at centre of the sector is between 15° and 90°, wherein an inner radius of the circular ring disc is selected such that a wall thickness of the wedge body generated by said radius has an extent of a few millimetres. An outer radius of the circular ring disc is defined by the radius difference, relative to the inner radius, required for the attachment of in each case one sleeve nut to two wedge body outer surfaces lying in the radial and axial directions. The wedge body has an extent in the axial direction which permits the attachment of two sleeve nuts at the standard spacing (radial wedge flanges L12.5) or at twice the standard spacing (radial wedge flanges L25), wherein the sleeve nuts have the same spacing as that in elements of class 1.0 “single bar elements”. In the case of angles at centre of less than 45°, one central bore is formed, or in the case of angles at centre of greater than 45°, two central bores are formed, in the wedge body in the axial direction and at the same radius at the sleeve nuts, wherein in the case of two, these have the same spacing to the axis. Said bores may however be dispensed with since they are present merely for construction reasons.

Also illustrated in FIG. 12 are elements from class 12.5 “axial wedge flanges L12.5” and from class 12.6 “axial wedge flanges L25”, these being produced analogously to the elements of class 12.2 and 12.3 “radial wedge flanges”, but their extent in the radial direction permitting the attachment of a single sleeve nut, whereas their extent in the axial direction permits the attachment of two sleeve nuts at the standard spacing (axial wedge flanges L12.5) or at twice the standard spacing (axial wedge flanges L25). Again, the wedge body has central bores in the axial direction, said central bores being formed at the same radius as the sleeve nuts and again being present merely for construction reasons. Finally, FIG. 12 illustrates a standard column 12.01 which may be of circular cylindrical form, in particular in the form of a tube, and which has an outer diameter corresponding to the U shape of the U-shaped element.

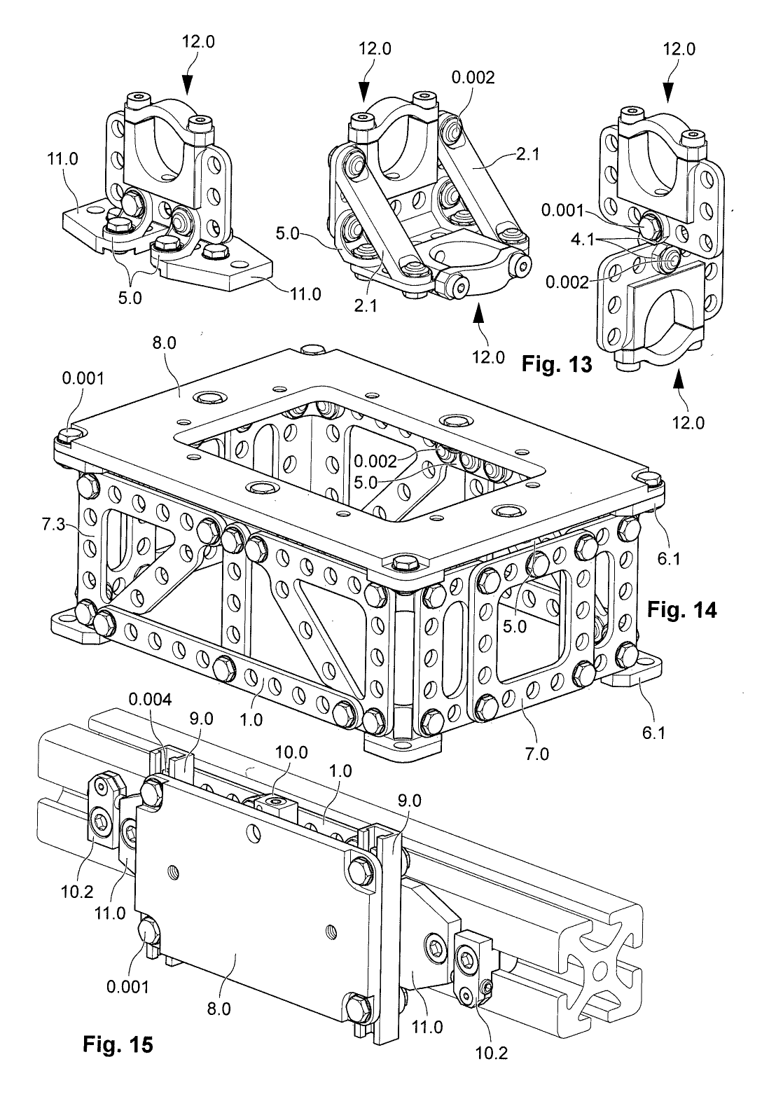

FIG. 13 shows further usage examples, wherein in a first example, a prism module 12.0 is mounted by means of four L90° angle elements 5.0 on two NS8 holders 11.0 (the fifth embodiment of FIG. 11) by means of cap screws 0.001 and sleeve nuts 0.002. The construction can be mounted via the NS8 holders 11.0 on a groove rail, and a standard column 12.01 can be held by means of the prism module 12.0. In a second example, two prisms 12.0 are screwed at right angles to one another via their side surfaces by means of two L90° angle elements 5.0 and two angle struts 2.1, whereby two standard columns 12.01 can be mounted at right angles. In a third example, again, two prisms 12.0 are screwed against one another by means of their holding plates, so as to be twisted through 90°, by means of two twist elements 4.1. Two crossing standard columns 12.01 can be held by means of this construction.

FIG. 14 shows a possible use of elements from the classes 1.0 “single bar elements”, 5.0 “L90° angle elements”, 6.1 “support elements”, 7.0 “90° frame”, 7.3 “90°×45°+1 frame”, 8.0 “workpiece carrier plates”, these being connected by means of cap screws 0.001 and sleeve nuts 0.002 or 0.003 and forming a pedestal. Here, the elements used are two bar elements with five orifices, two bar elements 1.0 with eleven orifices, two angle struts 2.1 for an isosceles triangle whose flanks have in each case four orifices, two L90° angle elements whose strips have three orifices and one orifice, four. L90° angle elements with a total of two orifices, eight support elements 6.1 in the sixth embodiment (cf. FIG. 6) with a total of three orifices, two 90° frames whose sides have five and nine orifices, four 90°×45°+L25 frames whose side strips have six, five, two and five orifices, wherein the first two and the second two of said four side strips stand at right angles on one another, and a workpiece carrier plate 8.0 whose dimensions correspond to those of “single bar elements” with thirteen and nine orifices, said workpiece carrier plate having in each case one orifice in its four corners, and furthermore having, at each centre of the edges, a further orifice offset inward slightly. The workpiece carrier plate 8.0 is formed as a hole pattern, such that other components behind the workpiece carrier plate 8.0 can also be seen.

Screw-fastened to each corner of the workpiece carrier plate 8.0 is a support element 6.1, wherein two strips, standing at right angles on one another, of the support element 6.1 lie parallel to and along edges of the workpiece carrier plate 8.0. Along two shorter edges of the workpiece carrier plate 8.0, the support elements 6.1 are connected by longer side strips of 90° frames 7.0; along longer edges of the workpiece carrier plate 8.0, at both support elements 6.1, in each case one 90°×45°+L25 frame 7.3 is screwed to that orifice which is common to the two side strips which stand at right angles on one another and which have six and five orifices, such that two 90°×45°+L25 frames 7.3 which lie along the same edge of the workpiece carrier plate 8.0 are directed symmetrically towards one another, and in each case the side strip which comprises six orifices lies along said edge. An L90° angle element 5.0 with a total of four orifices, is fixedly screwed, by means of a strip which has only one orifice, in each of the two orifices which lie in the centre of longer edges of the same side of the workpiece carrier plate 8.0, such that a strip which comprises three orifices lies parallel to the longer edge and between the orifice of the workpiece carrier plate 8.0 and edge. Said strip, which has three orifices, of the L90° angle element 5.0 serves, with outer orifices, for the screw fastening of the two 90°×45°+L25 frames 7.3 directed towards one another, whose in each case final orifice on the side strip lying parallel to the longer edge of the workpiece carrier plate 8.0 is aligned with an outer orifice, directed towards the 90°×45°+L25 frame 7.3, of the strip, which comprises 3 orifices, of the L90° angle element 5.0.

Fixedly screwed in a central orifice of the strip, which comprises three orifices, of the two L90° angle elements 5.0, at right angles to the workpiece carrier plate 8.0 and lying in the same plane as the two 90°×45°+L25 frames 7.3, is a bar element 1.0 having five orifices, to the other end of which a bar element 1.0 having eleven orifices is fastened at right angles and by means of an orifice situated in the centre, such that two ends of said bar element 1.0 come to lie at the outside on the 90°×45°+L25 frames 7.3, and the orifices formed in said ends of the bar element 1.0 can be screwed to the orifices existing in the underlying 90°×45°+L25 frame 7.3, said orifices being in each case one orifice, situated in the corner, of a side strip comprising two orifices. In each case one further support element 6.1 is fixed at corners, situated opposite the workpiece carrier plate 8.0, between the 90°×45°+L25 frame 7.3 and the 90° frame 7.0, such that said support element, mirror-symmetrically with respect to the support element 6.1 attached to the workpiece carrier plate 8.0, fixes the two frame elements 7.0 which are adjacent there. Two side strips, lying adjacent to one another, of in each case one 90°×45°+L25 frame 7.3 and one 90° frame 7.0 are additionally screwed to one another in the centre of their side strips by an L90° angle element 5.0 which comprises two orifices, wherein the L90° angle element 5.0 comes to lie on the same side of the side strips of the frame elements 7.3 as the strips, which are at right angles, of the support elements 6.1 fastened to the same frame elements 7.3.

FIG. 15 also shows a further exemplary application substantially in the form of a cross table. The cross table plate is formed as a rectangular workpiece carrier plate 8.0 which has four orifices in the corner regions and one orifice centrally on one side. Via the orifices in the corner regions, the workpiece carrier plate 8.0 is mounted by means of cap screws 0.001 and sleeve nuts with T-groove head 0.004 in T-groove rails 9.0, wherein the T-groove rails 9.0 are arranged spaced apart from one another in parallel such that the orifice arranged in the centre of the side comes to lie centrally between the T-groove rails 9.0. The T-groove rails 9.0 in turn are mounted on NS8 holders 11.0, wherein the cuboidal attachments of the NS8 holders 11.0 as per FIG. 11 are mounted on a conventional groove rail oriented at right angles to the T-groove rails 9.0. Parallel and laterally offset with respect to the conventional groove rail, and at right angles to and, with respect to the workpiece carrier plate 8.0, opposite the T-groove rails 9.0, a bar element 1.0 is screwed to the T-groove rails 9.0. Furthermore, on said bar element 1.0, a lateral readjustment unit 10.0 is mounted such that it comes to lie between the bar element 1.0 and the workpiece carrier plate 8.0. The peg of the lateral readjustment unit 10.0 projects into the orifice in the centre of the side of the workpiece carrier plate 8.0. When the cap screws 0.001 of the workpiece carrier plate 8.0 are loosened, the workpiece carrier plate 8.0 can be moved along the longitudinal axis of the T-groove rails 9.0 by rotating the adjusting screw of the lateral readjusting unit 10.0. Finally, the construction has two “special” lateral readjustment units 10.2 which are mounted on the conventional groove rail such that, by rotating the first threaded screw with Allen head, the NS8 holders 11.0, and therefore also the workpiece carrier plate 8.0, can be moved along the longitudinal axis of the conventional groove rail. In a heavy-duty embodiment, the steel thickness may be 5 mm, the orifice spacing 25 mm and the orifice diameter 10.5 mm.

In the figures described below, the cap screw 1100 and the sleeve nut 1200 of the first embodiment are shown in each case without a thread in order to be able to better highlight the essential features.

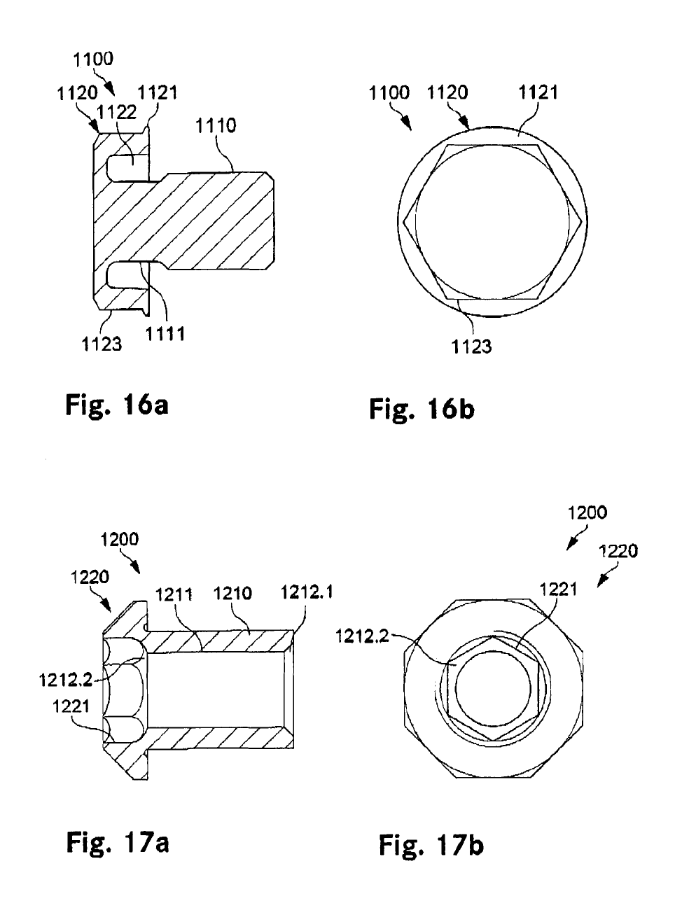

FIG. 16a shows a sectional illustration along a longitudinal axis of a cap screw 1100 of the first embodiment, comprising a threaded part 1110 and a cap 1120. The threaded part 1110 has substantially the shape of a circular cylinder. The thread of the threaded part 1110 has a thread axis in the plane of the figure. The threaded part 1110 is oriented coaxially with respect to the cap 1120. The thread of the threaded part 1110 does not project as far as the cap 1120 but rather merges into a narrowing 1111. The difference in radially measured diameter between the region of the thread and the narrowing 1111 corresponds approximately to the thread depth. The cap 1120 has substantially the shape of a straight cylinder which is closed on one side and which has a hexagonal base surface which serves as an external hexagon as a contact region for a torque wrench. The cap 1120 and the threaded part are now oriented and connected such that the perpendicular bisector of the hexagon runs coaxially with the axis of the threaded part 1110. The cap screw 1100 comprises a substantially U-shaped groove 1122, wherein the opening of the U shape is aligned axially. Here, a region of the narrowing 1111 which faces towards the cap 1120 forms an inner flank of the U shape, and the outer flank is formed by the inner wall of the cap 1120. The cap 1120 has, in the side facing towards the threaded part 1110, a radially outwardly projecting flange 1121.

FIG. 16b shows a schematic plan view of the cap 1120 of the cap screw 1100 as per FIG. 16a. Here, the external hexagon 1123 and the flange 1121 can be seen. In the present first embodiment, the external hexagon 1123 has roundings in the edge region axially opposite the flange 1121, which roundings can facilitate the engagement of a torque wrench.

FIG. 17a shows a sectional illustration along a longitudinal axis of a sleeve nut 1200 of the first embodiment, the axially shorter form. The sleeve nut 1200 comprises a sleeve 1210 with an internal thread 1211 and a shoulder 1220 connected coaxially to the sleeve 1210. The sleeve has, in the edge region at both sides, bevels 1212.1, 1212.2 of the inner edges, which bevels firstly symbolize the transition to the internal thread and secondly, in particular at the edge opposite the shoulder 1220, are intended to simplify the insertion of the cap screw 1100. The shoulder 1220 has a hexagon socket 1221 which merges via the bevel 1212.2 into the interior space of the sleeve 1210. By means of the bevel 1212.2, it is then achieved that a hexagonal wrench (Allen key) cannot pass into the threaded region, which could cause damage to the thread.

FIG. 17b shows a schematic plan view of the shoulder 1220 of the sleeve nut 1200 as per FIG. 17a. The head part has substantially an octagonal shape which, on the side opposite the sleeve 1210, has the shape of a circular truncated cone. By means of the octagonal shape, the sleeve nut 1200 can be rotationally secured during the screw fastening process. Formed within and coaxially with respect to the circular truncated cone is the hexagon socket 1221 which merges via the bevel 1212.2 into the internal thread 1211.

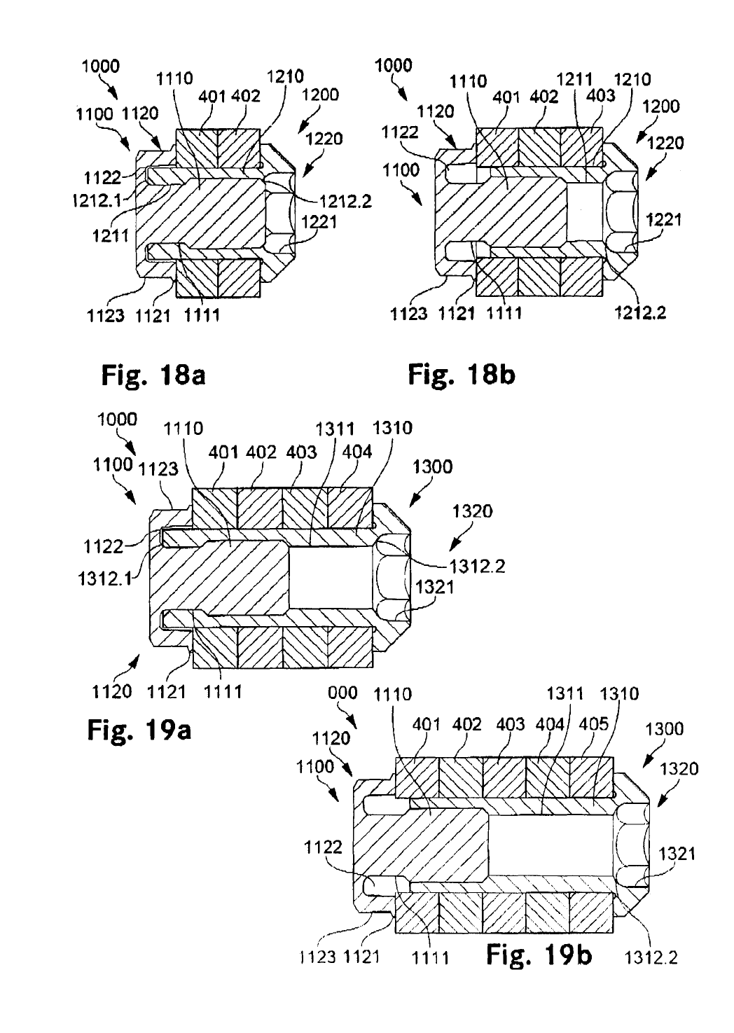

FIG. 18a shows a sectional illustration along a longitudinal axis through a screw connection 1000 of the first embodiment with a short sleeve nut 1200 in the second axial position, wherein two components 401, 402 are screwed together. The components 401 have circular cylindrical openings. The sleeve nut 1200 is guided through the openings. The cap screw 1100 is subsequently screwed with the threaded part 1110 into the internal thread 1211 of the sleeve 1210 of the sleeve nut 1200. For this purpose, a hexagonal wrench, for example a torque-regulated wrench, is used to screw the cap screw 1100 in, and an Allen key is used to counter-hold the sleeve nut 1200. During the screwing-in process, the sleeve 1210 moves with the region situated opposite the shoulder 1220 into the groove 1122 of the cap 1120 of the cap screw 1100. Here, the screw connection 1000 is designed such that, in the screwed-in and tightened state, the foremost region of the sleeve 1210 does not quite make contact with the cap 1120, such that the axial pressure acts substantially via the cap 1120 and the shoulder 1220 on the components 401, 402.

FIG. 18b shows a sectional illustration along a longitudinal axis through a screw connection 1000, substantially as per FIG. 18a, wherein the sleeve nut 1200 is in the first axial position and wherein three components 401-403 are screwed together. In contrast to FIG. 18a, the sleeve 1210 does not project into the groove 1122 of the cap screw 1100 but rather projects only as far as the end of the thread of the cap screw 1100. The thread of the cap screw is therefore, as in the second axial position, entirely in contact with the internal thread 1211 of the sleeve nut 1200.

FIGS. 19a and 19b show a sectional illustration along a longitudinal axis through a screw connection 1000 of the first embodiment with a long sleeve nut 1300 in the second axial position, wherein four components 401-404 or five components 401-405, respectively, are screwed together. The principle is basically identical to that shown in FIGS. 18a and 18b. The contrast with respect to FIGS. 18a and 18b lies in the fact that the long sleeve nut 1300 is formed so as to be longer than twice the thickness of a component 401 provided, such that instead of two or three components 401, 402, it is now possible for four or five components 401-405 to be screwed together. The head part of the long sleeve nut 1300 is identical to the head part of the short sleeve nut 1200. Correspondingly, in the figures, ‘one thousand three hundred’ numbers are used instead of ‘one thousand two hundred’ numbers.

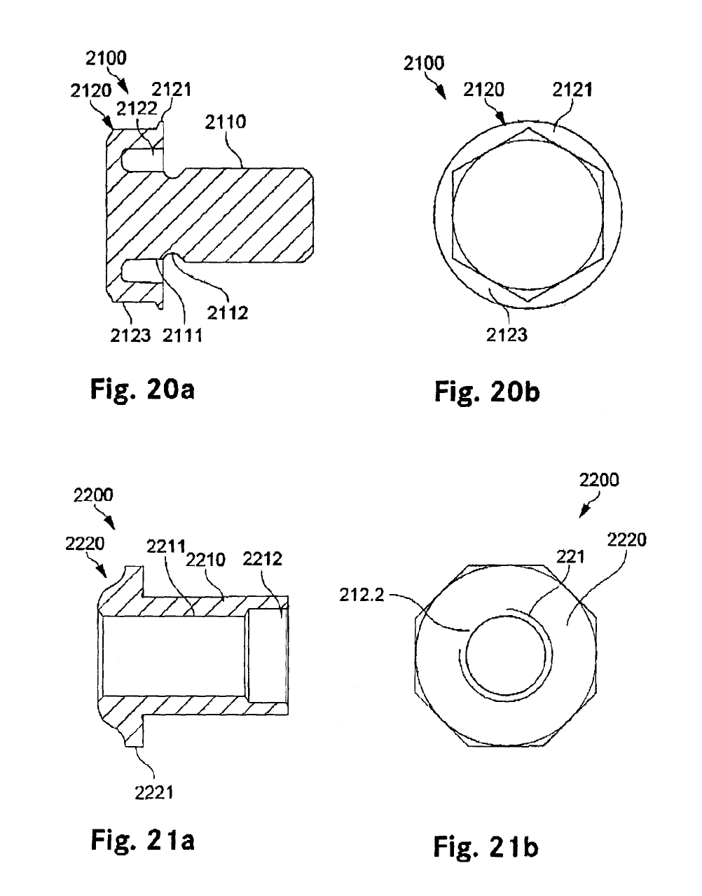

In the following FIGS. 20a to 23b, the cap screw 2100 and the sleeve nut 2200 of the second embodiment are described with regard to the differences in relation to the cap screw 1100 and the sleeve nut 1200 of the first embodiment. Again, the threads are not illustrated in order to be able to better highlight the essential features.

FIG. 20a shows a sectional illustration along a longitudinal axis of a cap screw 2100 of the second embodiment. Said cap screw differs from the cap screw 1100 of the first embodiment substantially in that the narrowing 2111 has approximately a diameter which corresponds to the diameter of the threaded part 2110. Between the narrowing 2111 and the threaded part 2110 there is provided an encircling notch 2112 which has a smaller diameter than the narrowing 2111.

FIG. 20b shows a schematic plan view of the head part 2120 of the cap screw as per FIG. 20a, which does not differ from the plan view as per FIG. 16b.

FIG. 21a shows a sectional illustration along a longitudinal axis of a short sleeve nut 2200 of the second embodiment. Said sleeve nut differs from the sleeve nut 1200 of the first embodiment in that a hexagon socket is not provided, but rather the internal thread 2211 extends through the head part. At the end opposite the head part, an undercut 2212 is provided in the inner wall. The sleeve nut 2200 has a greater inner diameter in the region of the undercut 2212 than in the region of the internal thread 2211.

FIG. 21b shows a schematic plan view of the head of the sleeve nut 2200 as per FIG. 21a, wherein in comparison with the sleeve nut 1200, only the hexagon socket has been omitted. The present sleeve nut 2200 is therefore held fixed by means of the octagonal outer contour 2321, for example using a wrench, during the screw fastening process.

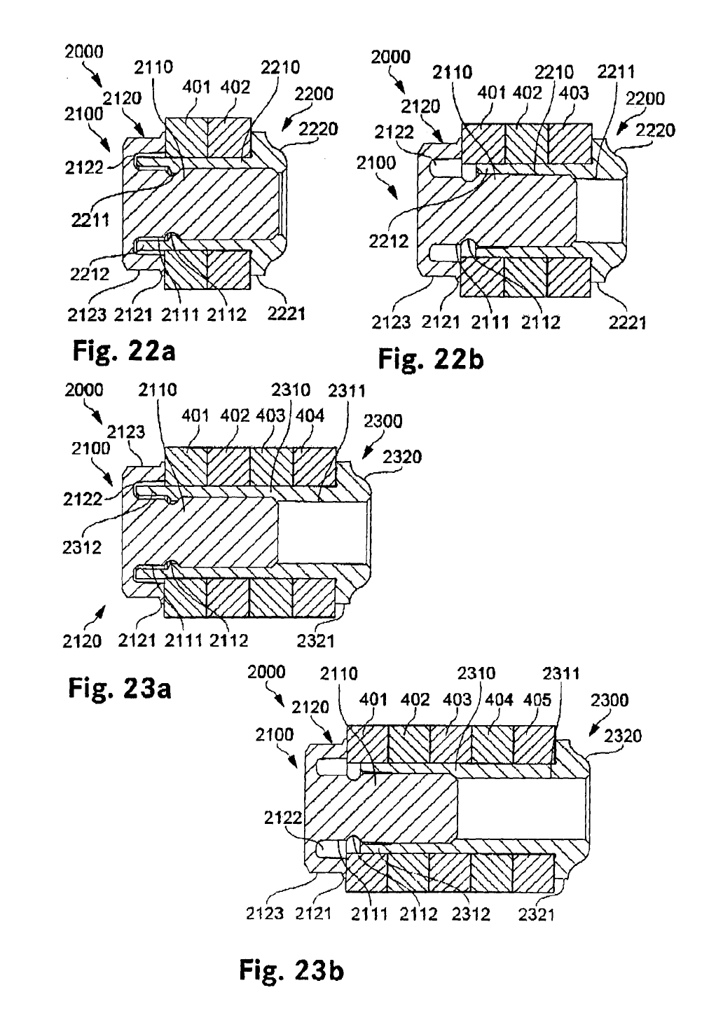

FIGS. 22a, 22b, 23a and 23b show in each case a sectional illustration along a longitudinal axis through a screw connection 2000 of the second embodiment corresponding to FIGS. 18a, 18b, 19a, 19b, wherein in contrast, the sleeve nuts 2200 and 2300 respectively and the cap screw 2100 according to the second embodiment are used.

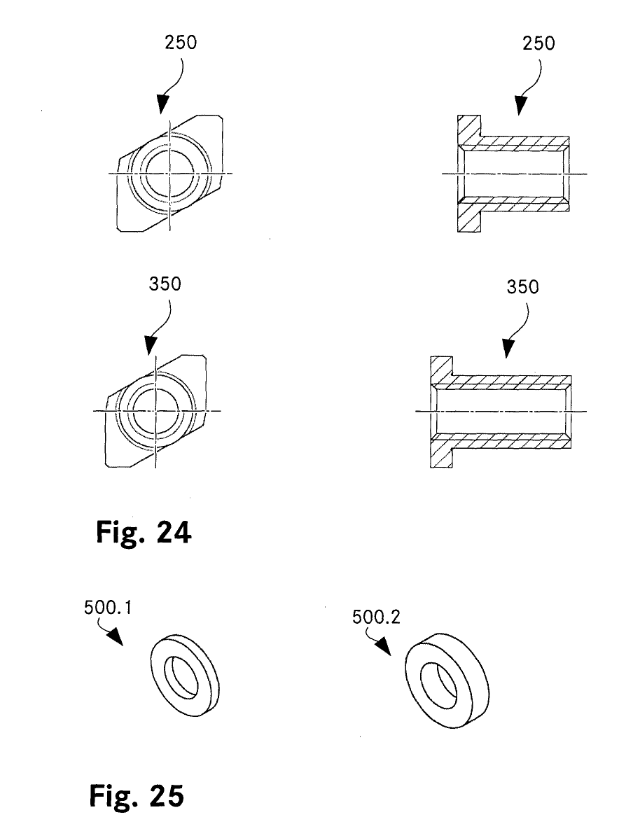

FIG. 24 shows a plan view and a sectional illustration along a longitudinal axis through a sleeve nut for groove rails 250, 350, in the long embodiment 350 and the short embodiment 250. The sleeves of the sleeve nuts for groove rails 250, 350 correspond to those of the sleeve nuts 1200, 1300. The internal thread runs through the sleeve nuts for groove rails 250, 350. In contrast to the latter, the sleeve nuts for groove rails 250, 350 have a head which, in plan view, is substantially in the shape of a parallelogram, wherein the parallelogram has two different heights. The smaller height is dimensioned such that the head can be inserted from above into an undercut groove rail. By being rotated about its longitudinal axis, the head engages behind the undercut flanks of the groove rail, and is thus fixed axially in the groove rail.

In variants, the sleeve of the sleeve nuts 250, 350 may also have, as per the second embodiment of the sleeve nut 2300, an undercut (not illustrated) at the end situated opposite the head.

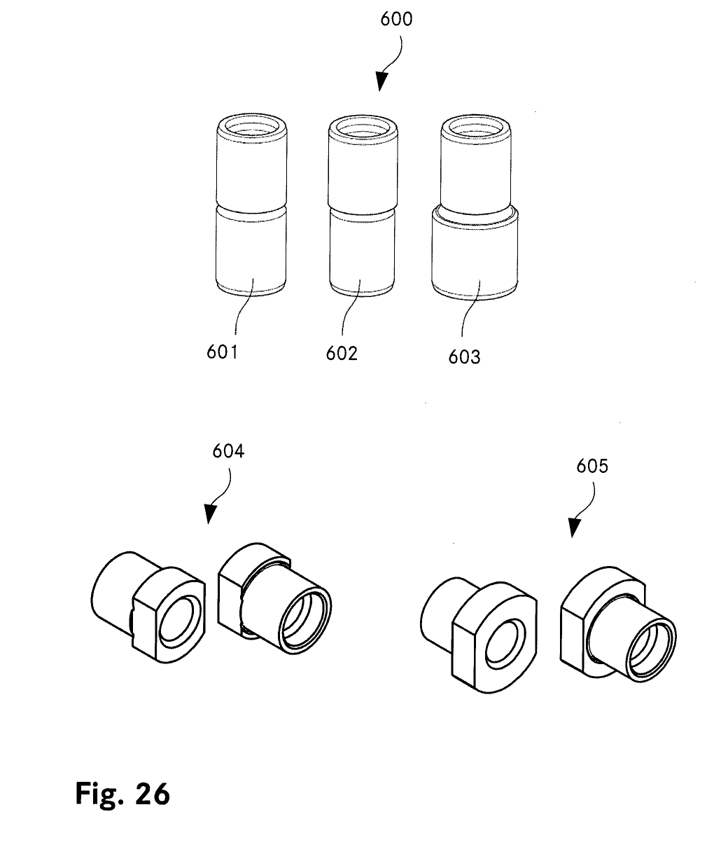

FIG. 25 shows two spacer discs 500.1, 500.2 which can be used for length compensation of the sleeve nuts/cap screws. The spacer discs are of conventional design and have an inner diameter corresponding to the sleeves 210, 310. The thickness of the spacer disc 500.1 is preferably 1.5 mm, and the thickness of the spacer disc 500.2 is preferably 3.0 mm, whereby different spacings can be set through the combination of a plurality of spacer discs. The thickness of the spacer discs may also be dimensioned differently, or a plurality of different thicknesses may be provided.

FIG. 26 shows oblique views of two embodiments of stepped pins 601, 602, which are in each case of sleeve-like construction and have a continuous thread, preferably an M 5 thread. At one end of the sleeve, the stepped pins 601, 602 have in each case one flange which has a cross-sectional area with the basic shape of a circle with two circular-segment-shaped cutouts with parallel chords. In the first embodiment 601, the circle diameter is 8 mm and the chord spacing is 6 mm. In the second embodiment 602, the circle diameter is 10 mm and the chord diameter is 8 mm.

In summary, it can be stated that, by means of the invention, a modular system is created which permits the construction of particularly solid and precise structures by which machine elements in machine construction, special machine construction and plant construction can be joined together.

1. Modular system for manufacturing structures for machine, special machine and plant construction, comprising a plurality of components which are of elongate form and which each have at least two orifices, wherein two components can be connected to one another in a play-free manner by means of a connecting element.

2. Modular system according to claim 1, characterized in that the connecting element is designed such that pinning and screw fastening of at least two components arranged such that in each case one orifice of the at least two components are arranged coaxially can be attained through said orifices.

3. Modular system according to claim 1, wherein the components are selected from at least two of the following classes:
a) bar elements having one or more parallel rows of orifices, wherein there is a spacing a between adjacent orifices in one row and if appropriate between the rows;
b) linear struts having a row of orifices, wherein adjacent orifices have a spacing of \sqrt{2} a to one another;
c) Z struts having two orifices which are arranged at the ends and which are aligned parallel to one another, and wherein axes running through the orifices lie in the Z plane;
d) C struts which have two coaxial orifices;
e) angle struts having two orifices which are arranged at the ends and which are oriented at right angles to one another, wherein axes running through the orifices have a point of intersection;
f) corner elements which comprise three side surfaces connected to one another in pairs orthogonally via an edge region, wherein the side surfaces have in each case at least one orifice;
g) frame elements, formed as rectangular frames with orifices, wherein adjacent orifices have a spacing a from one another, and/or which frame elements are formed substantially as right-angled isosceles triangles, wherein a spacing between adjacent orifices is \sqrt{2} a on the hypotenuse and a on the cathetus;
h) workpiece carrier plates (8.0) for the mounting of plant elements, said workpiece carrier plates being formed as rectangular plates and having orifices in the corners;
i) groove rails, wherein side walls are undercut and orifices are arranged with a spacing a in a groove base, and holding elements which comprise a plate with orifices and a holding part screwed to the plate, wherein when fixed in the groove rail, the holding part engages behind the undercut side walls.

4. Modular system according to claim 1, characterized in that the orifices of the elements are toleranced in accordance with DIN H8.

5. Modular system according to claim 1, characterized in that said modular system comprises a component which is formed as a regulating element which has two orifices on the ends, wherein a spacing between the two orifices can be varied in a continuously variable manner in a predefined range.

6. Modular system according to claim 5, characterized in that the regulating element comprises two elements which are arranged so as to be linearly movable relative to one another and can be fixed relative to one another by means of a clamping screw.

7. Modular system according to claim 6, characterized in that the spacing between the orifices can be adjusted by means of an adjusting screw.

8. Modular system according to claim 1, characterized in that said modular system comprises an adjusting unit which comprises a fixing element and a screw rotatably mounted on the fixing element, and which additionally has an orifice.

9. Modular system according to claim 8, characterized in that the adjusting unit furthermore has a fixing device for fixing the screw.

10. Modular system according to claim 8, characterized in that the screw is mounted in a rotatable and axially fixed manner on the fixing element, and the adjusting unit comprises an adjusting element which has an internal thread for interacting with the screw and also has a contact region for an orifice.

11. Modular system according to claim 1, characterized in that the connecting element is formed as a screw connection, having a first element comprising an external thread and a first head part, and having a second element comprising an internal thread and a second head part, characterized in that, when the first element is screwed fully into the second element, a surface between the first head part and the second head part is formed as a smooth circular cylinder.

12. Modular system according to claim 11, characterized in that the first element can be screwed with the second element axially into at least two positions, wherein the spacing between the first head part and the second head part is greater in the first axial position than in the second axial position.

13. Modular system according to claim 11, characterized in that the first element is formed as a cap screw.

14. Modular system according to claim 11, characterized in that the external thread part comprises an encircling groove adjacent to the first head part.

15. Modular system according to claim 11, characterized in that the second element is formed as a sleeve nut, wherein the sleeve is formed as a smooth circular cylinder.

16. Modular system according to claim 9, characterized in that the fixing device is designed as a clamping screw, such that the screw can be fixedly clamped when the clamping screw is tightened.

17. Modular system according to claim 11, characterized in that the surface between the first head part and the second head part is suitable for pinning.

18. Modular system according to claim 15, characterized in that the sleeve is suitable for pinning, and has an internal thread.
